(19) United States
(12) Patent Application Publication
(10) Pub. No.: US 2016/0117713 A1
(43) Pub. Date: Apr. 28, 2016

(54) ERROR DETECTION AND CORRECTION IN COMPLEX ENTITLEMENT BENEFITS

(71) Applicant: eBay Inc., San Jose, CA (US)

(72) Inventors: Anil Kumar, Karnataka (IN); Mayank Gupta, Milpitas, CA (US); Suresh Chinnathambi, Cupertino, CA (US); George B. Petkov, Pleasanton, CA (US); Diwakar Magadi, San Jose, CA (US); Gang Ye, Sunnyvale, CA (US); David Xie, Pleasanton, CA (US)

(21) Appl. No.: 14/873,819

(22) Filed: Oct. 2, 2015

Related U.S. Application Data
(63) Continuation of application No. 13/034,538, filed on Feb. 24, 2011.
(60) Provisional application No. 61/308,890, filed on Feb. 26, 2010.

(51) Int. Cl. G06Q 30/02

(52) U.S. Cl. CPC G06Q 30/0222

(57) ABSTRACT

Methods and systems for identifying and recovering from errors in the application of complex entitlement benefits within a distributed transaction processing system are disclosed. For example, a method can include identifying a processing error within a distributed transaction processing system, assessing an impact of the processing error, and determining a recovery strategy to minimize the impact of the processing error. The processing error can be associated with the application of an entitlement to a plurality of transactions. The entitlement can include a defined benefit and a benefit counter. The benefit counter can control a quantity of transactions allowed to receive the entitlement. The impact of the processing error can be assessed in regard to the plurality of transactions.

### RELATED APPLICATIONS

This patent application is a continuation of U.S. application Ser. No. 13/034,538, filed Feb. 24, 2011, which claims the benefit of U.S. Provisional Application Ser. No. 61/308,890, filed on Feb. 26, 2010, which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2010, eBay Inc. All Rights Reserved.

### TECHNICAL FIELD

This application relates generally to error detection and correction in complex entitlement benefits over a distributed network, and more specifically to methods and systems to identifying errors in the application of complex entitlement benefits within a distributed transaction processing system, assessing an impact of the errors, and generating a recovery strategy responsive to the errors.

### BACKGROUND

Various web sites on the Internet allow both individuals and organizations to develop stores to sell products and services. Web sites such as amazon.com (from Amazon, Inc. of Seattle, Wash.) or ebay.com (from eBay, Inc. of San Jose, Calif.), generically referred to as marketplaces, can be used to list individual items for sale or maintain an entire store (e.g., collection of items). As marketplace sites have become more and more popular these sites look for ways to attract and retain sellers. Additionally, as the volume of transactions has increased, especially with regard to power sellers, the marketplace sites find it increasingly difficult to manage application of incentives.

### BRIEF DESCRIPTION OF THE DRAWINGS

Some embodiments are illustrated by way of example and not limitation in the figures of the accompanying drawings in which:

FIG. 1 is a block diagram illustrating an example network-based system within which various example embodiments can be deployed.

FIG. 2 is a block diagram illustrating various example applications that can be included within the network-based system 102, according to an example embodiment.

FIG. 3 is a table depicting various example entitlements, according to an example embodiment.

FIG. 4A-4C are tables depicting various example fee structure associated with various transactions available within a network-based system, according to an example embodiment.

FIG. 5A is a table depicting an example data structure for an entitlement, according to an example embodiment.

FIG. 5B is a table depicting various examples of tracking entitlement benefit usage, according to an example embodiment.

FIG. 6 is a block diagram illustrating an example system architecture for managing complex entitlement, according to an example embodiment.

FIG. 7A-7H are user interface screens illustrating various examples of messaging related to entitlements within a network-based system, according to an example embodiment.

FIG. 8A-8B are tables depicting various example revision behaviors based on status changes associated with a particular transaction, according to an example embodiment.

FIG. 9 is a timeline illustration depicting application of an example entitlement to various transactions over time, according to an example embodiment.

FIG. 10A-10B are user interface screens illustrating various examples of messaging related to entitlements within a network-based system, according to an example embodiment.

FIG. 11A-11F are user interface screens illustrating various examples of messaging related to entitlements within a third-party application accessing a network-based system via an application programming interface, according to an example embodiment.

FIG. 12 is a block diagram illustrating an example recovery infrastructure, according to an example embodiment.

FIG. 13 is a block diagram illustrating entity relationships for an example entitlement, according to an example embodiment.

FIG. 14 is a table depicting various entitlement recovery solutions, according to an example embodiment.

FIG. 15A is a timeline illustrating an example entitlement recovery scenario, according to an example embodiment.

FIG. 15B is a table depicting various recovery scenarios based on an example timeline, according to an example embodiment.

FIG. 16A is a timeline illustrating an example entitlement recovery scenario, according to an example embodiment.

FIG. 16B-16D are tables depicting various recovery scenarios based on an example timeline, according to an example embodiment.

FIG. 17A is a timeline illustrating an example entitlement recovery scenario, according to an example embodiment.

FIG. 17B is a table depicting various recovery scenarios based on an example timeline, according to an example embodiment.

FIG. 18A is a timeline illustrating an example entitlement recovery scenario, according to an example embodiment.

FIG. 18B is a table depicting various recovery scenarios based on an example timeline, according to an example embodiment.

FIG. 19 is a block diagram illustrating an example data structure for an input file for recovery, according to an example embodiment.

FIG. 20 is a table depicting various example attributes included within an example data structure for batch recovery, according to an example embodiment.

FIG. 21 is a code fragment illustrating an example data structure for a recovery input file, according to an example embodiment.

FIG. 22 is a table depicting various example input parameters to an example recovery process, according to an example embodiment.

FIG. 23 is a code listing illustrating an example recovery algorithm, according to an example embodiment.

FIG. 24A is a table depicting various recovery use cases according to an example embodiment.

FIG. 24B is a table depicting an additional example entitlement use case, according to an example embodiment.

FIG. 25A-25C are diagrams illustrating various entitlement durations, according to an example embodiment.

FIG. 26 is a block diagram of machine in the example form of a computer system within which instructions, for causing the machine to perform any one or more of the methodologies discussed herein, may be executed.

FIG. 27 is a flowchart illustrating an example of recovery and reconciliation state transitions, according to an example embodiment.

### DEFINITIONS

Marketplace—Marketplace can be used to refer to a network-based system capable of enabling multiple merchants to sell goods and services over a quasi-public network, such as the Internet. eBay.com (from eBay, Inc. of San Jose, Calif.) is a commercial example of a marketplace system.

Publication system—A publication system can be used to refer to a network-based system capable of enabling multiple users to publish information over a quasi-public network, such as the Internet. Craigslist.org (from Craigslist of San Francisco, Calif.) is a commercial example of a publication system.

SYI—Sell Your Item—SYI is an example transaction flow associated with a user posting an item for sale within an online marketplace or publication system.

RYI—Revise Your Item—RYI is an example transaction flow associated with a user revising an item listing within an online marketplace or publication system.

RTP—Real-Time Promotions—RTP can be used to refer to different methods of promoting products or services within a network-based system, such as a network-based marketplace or network-based publication system. RTP is also used to refer to promotional offers associated with a particular transaction.

IF—Insertion Fee—IF is a fee paid by a user to insert a listing into a marketplace or publication system.

FVF—Final Value Fee—FVF is a fee paid by a seller based on the final value obtained for a particular listing. For example, if a seller lists a item using an auction type of listing the FVF reflects a fee paid based on the ending auction price.

BIN—Buy-It-Now—BIN is a type of promotional listing that enables a user to purchase the listed item immediately.

API—Application Programming Interface—An API represents a programmable interface for a certain system or software application.

LSD—Listing Session Detail—LSD can reference to information collected during a session associated with the listing of an item within a network-based publication system.

Entitlement benefit application rules—Entitlement benefit application rules are rules used to determine when a particular benefit may be applied to a transaction (e.g., listing of a product or service within a network-based publication system). The following specification may refer to entitlement benefit application rules as benefit criteria, conditions, qualifying conditions, criteria, or rules, any of these references should be considered analogous (unless specifically indicated as different). In some example embodiments, qualifying conditions can refer to conditions that qualify a particular user to be eligible for application of an entitlement. In these examples, qualifying conditions are applied prior to evaluation of any entitlement benefit application rules.

### DETAILED DESCRIPTION

In the following description, for purposes of explanation, numerous specific details are set forth in order to provide an understanding of various embodiments of the inventive subject matter. It will be evident, however, to those skilled in the art that embodiments may be practiced without these specific details. Further, well-known instruction instances, protocols, structures, and techniques have not been shown in detail. As used herein, the term “or” may be construed in an inclusive or exclusive sense, the term “user” may be construed to include a person or a machine, the term “interface” may be construed to include an application program interface (API) or a user interface, and the term “database” may be construed to include a database or a NoSQL or non-relational data store (e.g., Google's BigTable or Amazon's Dynamo).

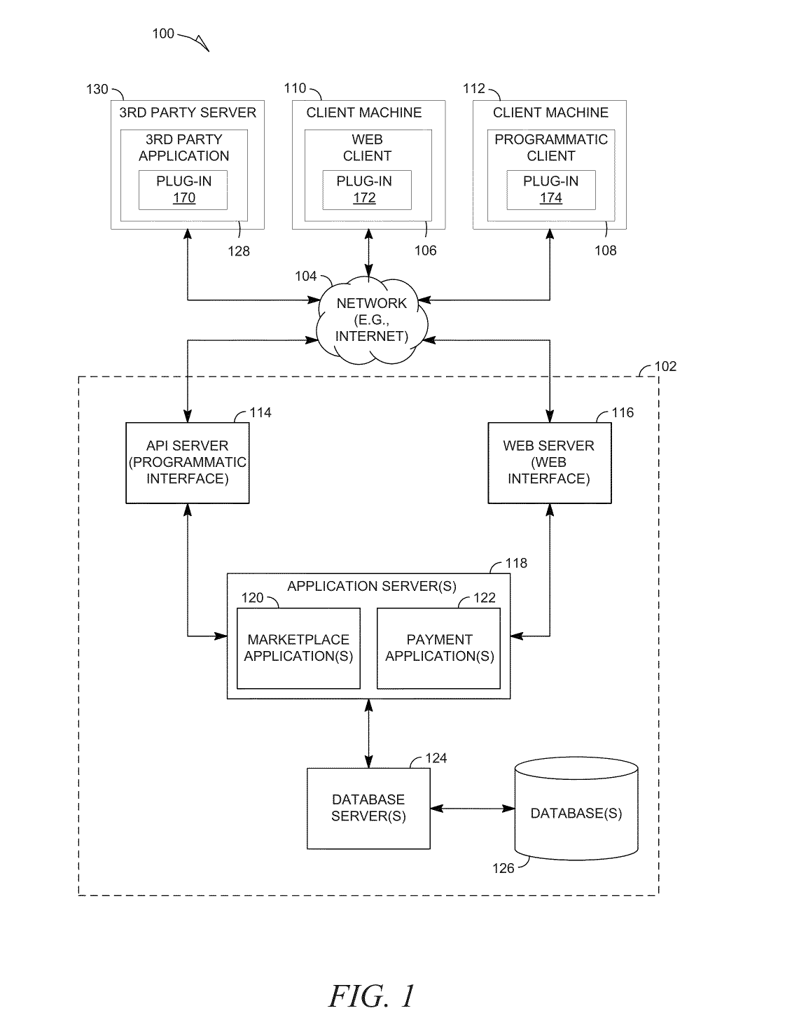

FIG. 1 is a network diagram depicting a client-server system 100, within which various example embodiments may be deployed. A networked system 102, in the example forms of a network-based marketplace or other publication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash.) and a programmatic client 108 executing on respective client machines 110 and 112. Each of the one or more clients may include a software application module (e.g., a plug-in, add-in, or macro) that adds a specific service or feature to a larger system. The software application module may be separate from but tightly-integrated into a user interface and functionality of a software application, such as a spreadsheet application. The software application may be a client software application running on a client machine. For example, FIG. 1 depicts plug-ins 172 and 174 as being included in the web client 106 and the programmatic client 108, respectively. The software application module may be optionally deployed in the same environment as the software application such that the software application module can be accessed from within the software application. The software application module may be optionally enabled or disabled within the environment (e.g., user interface) of the software application. The software application module may appear to be a part of the software application by, for example, providing user interface components or widgets (e.g., menus, toolbars, menu commands, toolbar commands, and so on) that can be enabled, disabled, added to, or removed from standard user interface components or widgets provided by the software application.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases or NoSQL or non-relational data stores 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102. FIG. 1 depicts plug-in 170 as being included in the third party application 128.

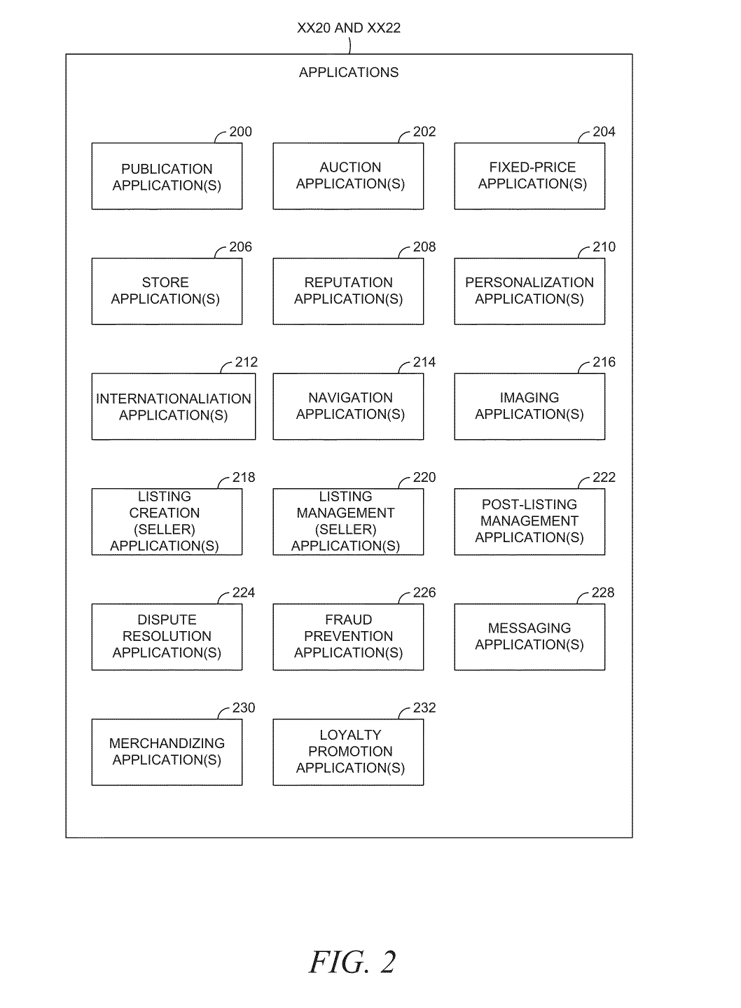

FIG. 2 is a block diagram illustrating multiple applications 120 and 122 that, in one example embodiment, are provided as part of the networked system 102. The applications 120 and 122 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 126 via the database servers 128.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 are shown to include at least one publication application 200 and one or more auction applications 202 which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the networked system 102, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application 236 (as an example of a navigation application) may enable key word searches of listings published via the networked system 102. A browse application 238 may allow users to browse various category, catalogue, or inventory data structures according to which listings may be classified within the networked system 102. Various other navigation applications may be provided to supplement the search and browsing applications.

In order to make listings, available via the networked system 102, as visually informing and attractive as possible, the marketplace applications 120 may include one or more imaging applications 216 which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. The listing creation application 218 and listing management applications 200 may allow sellers to manage listing in bulk (e.g., in a single operation, such as by an uploading of a file) and provide templates for sellers to manage category-specific, vendor-specific, or general-type-specific (e.g., catalog or ticket) listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of operations in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102. These messages may, for example, advise users regarding the status of listings at the networked system 102 (e.g., providing “outbid” notices to bidders during an auction process or providing promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 80 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotion applications 232. For example, a buyer may earn loyalty or promotions points for each transaction established and/or concluded with a particular seller, and may be offered a reward for which accumulated loyalty points can be redeemed.

### Entitlements

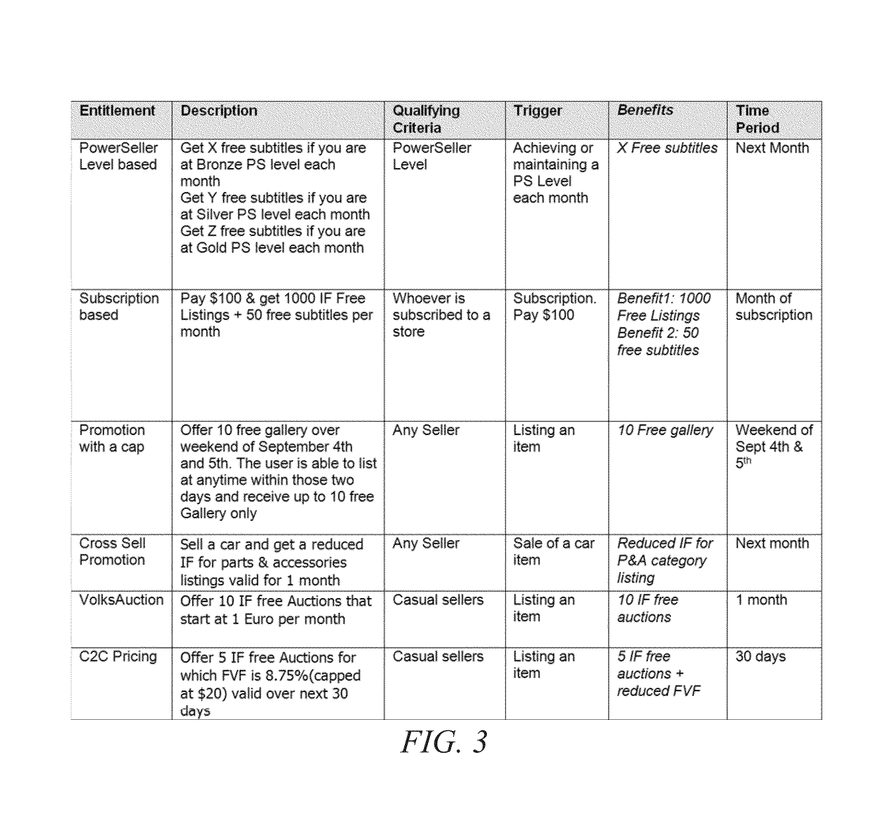

An entitlement enables an entity (e.g., eBay) to offer a party involved in a marketplace transaction (e.g., a buyer, a seller, or a user representing the buyer or the seller) a special fee or price for their listing on the networked system 102 based on certain qualification as part of a promotional offer or a paid entitlement. For example, the special fee or price may be based on the party's usage of or involvement with the networked system 102. An entitlement may also be referred to as a special offer or as an element of a special offers program. An entitlement may have one or more of the following characteristics: a qualifying criterion, a triggering action or event (voluntary or automatic), a benefit, a benefit criterion, or a time period. The qualifying criterion (rule) may specify attributes or criteria that the party must meet to qualify or be pre-qualified for the entitlement. The triggering action (event) may be an automatic or voluntary action by the party that establishes the party's eligibility for the entitlement. The triggering event may be an occurrence of a particular event (e.g., the reaching by the party of a particular qualifying criterion) that automatically establishes the party's eligibility for the entitlement. The benefit may be a variable, quantifiable benefit (e.g., a benefit having a monetary value) having an upper or a lower bound. The actual amount of the benefit may depend on various factors, including the qualifying criterion, the triggering action or event, the benefit criterion, or the time period. The benefit criterion may specify a criterion the party must satisfy to receive the benefit. For example, the benefit criterion may specify that a seller must list a product in a Media product category to receive the benefit. In this case, the seller may not receive the benefit for listing a product in a Tech category. The time period may specify a time period in which the benefit is valid. For example, the time period may specify that the benefit will expire after a particular date and time. In this case, the benefit may no longer be valid or received after the particular date and time. The characteristics of the entitlement may be defined by an entity offering the entitlement. The entitlement may have multiple ones of each of the characteristics (e.g., the entitlement may have multiple qualifying criteria, actions, triggers, benefit criteria, or time periods). FIG. 3 depicts examples of various entitlements.

In certain examples, the entitlement may not include an indefinite promotion (e.g., the benefit may have to be used up within a valid time frame; in other words, an entitlement may be analogous to a “use it or lose it” model of cell phone plans). For example, the benefit may give a promotional price on one or more “next” listings by a seller. In an example, the benefit may not be cyclic (e.g., the benefit may give a seller one free item listing for every two paid item listings). In another example, the benefit may not be given at an invoice level (e.g., the benefit may not be given as a discount to a volume seller).

The entitlement may be a paid entitlement or an unpaid entitlement. A paid entitlement may require the party to pay a specific fee to get the entitlement. The entitlement may be a subscription-based entitlement, which may require the party to pay a recurring fee, or a pay-as-you-go entitlement, which may require the party to pay by usage, or a one-time use entitlement, which may require the party to make a one-time payment. For example, a subscription-based entitlement may require a seller to pay $10 per month to get 100 IF free listings. Or a one-time use entitlement may require a seller to pay $5 to get 10 bold free that is valid for the month of February. Such a one-time use entitlement may be offered to sellers only once. Or a pay-as-you-go entitlement may require a seller to pay $7 to get 100 subtitles free that is valid for 1 month. Such a pay-as-you-go entitlement may be offered to sellers for a specific period of time. An unpaid entitlement may be offered for free to the party if the party meets specific criteria. For example, an unpaid entitlement may offer three free listing during the month of December to sellers having lapsed accounts. The entity offering the entitlement may define what constitutes a lapsed account based on a lack of usage of the account over a specific time period or other criteria.

The entitlement may apply to all or a subset of categories of products, such as categories of products offered for sale on the networked system 102. Additionally, the entitlement may support various real-time promotion (RTP) formats, fee types, and features. The formats may include an auction format (including an auction with a Buy-It-Now (BIN) option), a fixed price format, a store inventory format (SIF), an ad format, a personal offer format, or a second chance offer format. The fee types may include an insertion fee (IF) type, a final value fee (FVF) type, or a feature fee type. The entitlement may have benefits associated with an IF and FVF that go together such that, for example, a fee associated with the entitlement is rebalanced. That is, a promotional IF and FVF may be applied to listings qualifying for the entitlement. For example, the seller may get five auctions with $0.0 IF over 30 days. Additionally, these five auctions may have a special FVF of 8.75%. In other words, the five auction items that qualified for this entitlement may have a promotional IF $0.0 and a promotional FVF of 8.75%. Items sold in additional auctions beyond the five auctions may be charged a regular IF and FVF.

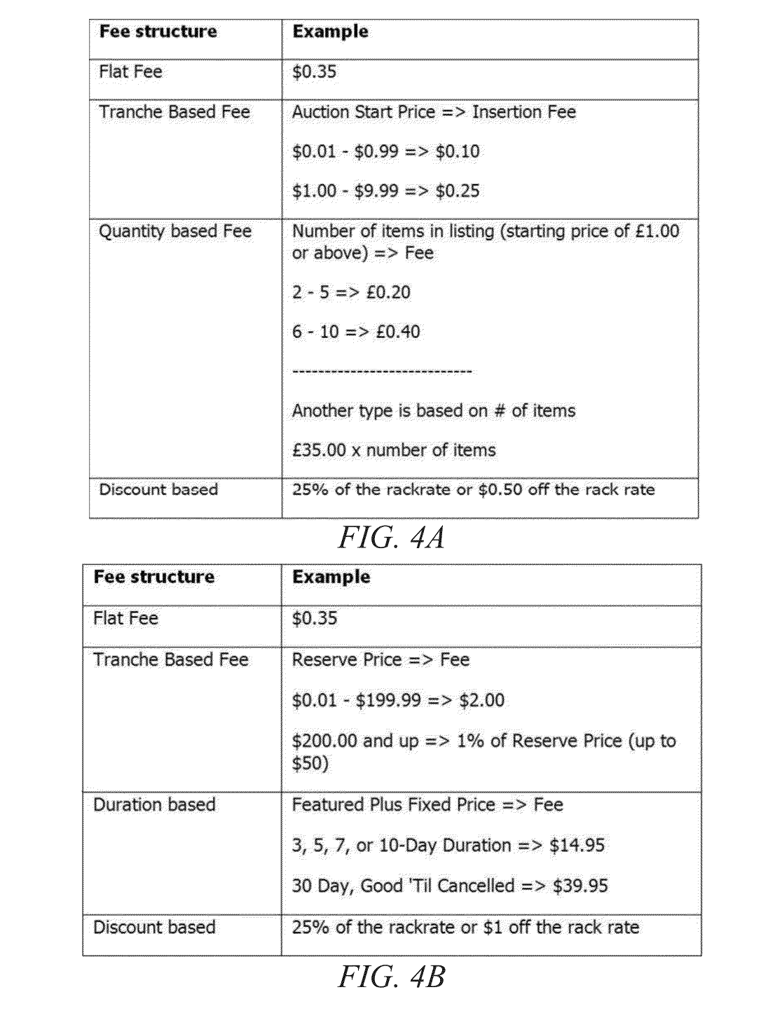

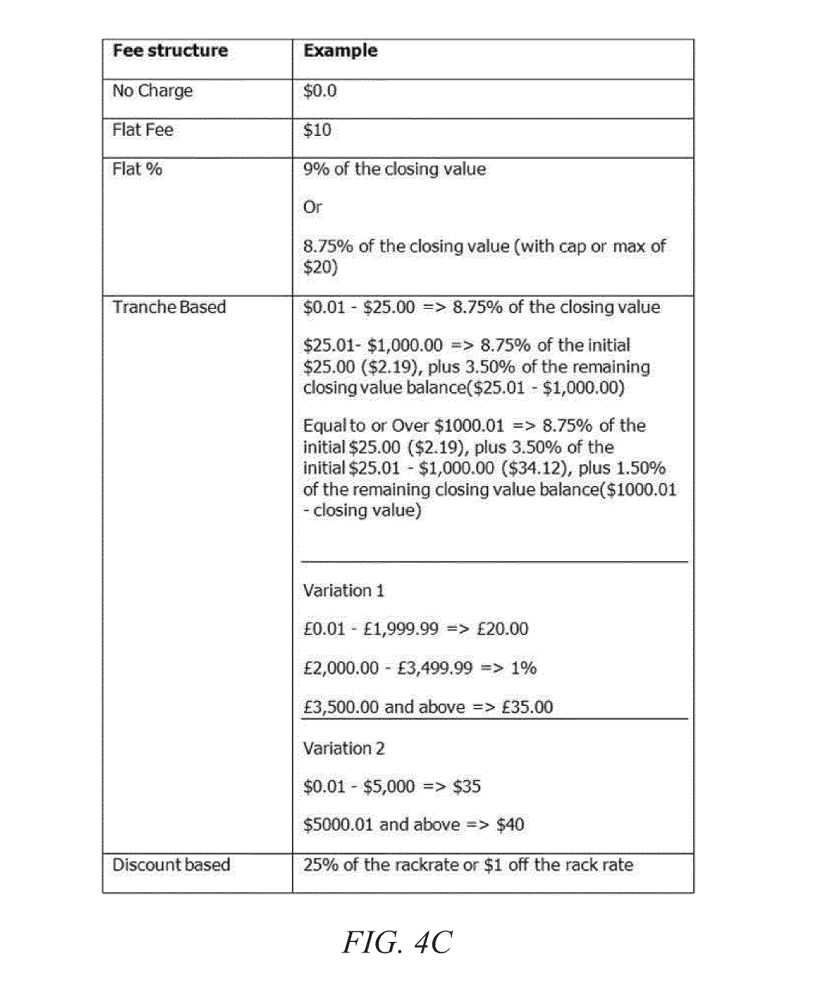

The entitlement may have a particular fee structure or type, including a fixed-amount, a flat-percentage, a tranche-based, a fixed-with-percentage-discount, or a fixed-with-fixed-discount fee structure. The fixed-amount fee structure may include charging a fixed amount (e.g., $0.35). The flat-percentage fee structure may include charging a flat percentage fee. In this case, the fee may have a cap or maximum amount as a ceiling (e.g., 5% with a cap or maximum fee of $20). The tranche-based fee structure may include charging a tier-based fee. Each tier may have a separate percentage or fixed fee. The fees across the various tiers may be cumulatively added to arrive at the final fee. A tier may be defined by the entity offering the entitlement. For example, the fee for an item selling for between $0.01 and $50.00 may be 8.00% of the closing value. The fee for an item selling for between $50.01 and $1,000.00 may be 8.00% of the initial $50.00 plus 4.50% of the remaining closing value balance. The fixed-with-percentage-discount fee structure may include applying a percentage discount on the base fee. For example, the fee may be 50% off of the FVF. The fixed-with-fixed-discount fee structure may include applying a fixed amount discount on the base fee. For example, the fee may be $0.50 off of the Bold Fee (e.g., the fee that a seller must pay to list an item using a bold font). Additionally, the entitlement may have a success-based fee. The success-based fee may include applying a fixed amount plus a percentage fee (e.g., $0.99+19% FVF on sale price). FIG. 4A depicts example insertion fees having various fee structures. FIG. 4B depicts example feature fees of various fee structures. FIG. 4C depicts example final value fees of various fee structures.

The features the entitlement may relate to features of the networked system 102, such as those provided by application 120 and 122, including features like eBay's BIN, Gallery Plus, Subtitles, Scheduled Listing, Listing Designer, 10-day duration or special duration, Gift Services, Bold, Border, Highlight, Featured Plus, Featured First(Gallery Featured), Home Page Featured, Value Pack, Pro Pack, Pro Pack for Motors, Each additional picture, Picture Pack (1-6 pictures), Picture Pack (7-12 pictures) or Picture Pack Plus, Cross Border Trading, Gallery, International Listing, and Picture Show features. In an example, the entitlement can related to a particular aspect or element of a transaction. For example, a transaction within the networked system 102 can include a multi-item purchase, with the entitlement only applying to certain items (e.g., accessories purchased in combination with a major item). The entity offering the entitlement may specify details regarding the formats, categories, features, and fee structures that the entitlement supports. The entity offering the entitlement may specify the details using rule-based definitions. The rule-based definitions may be managed via the applications 120 and 122.

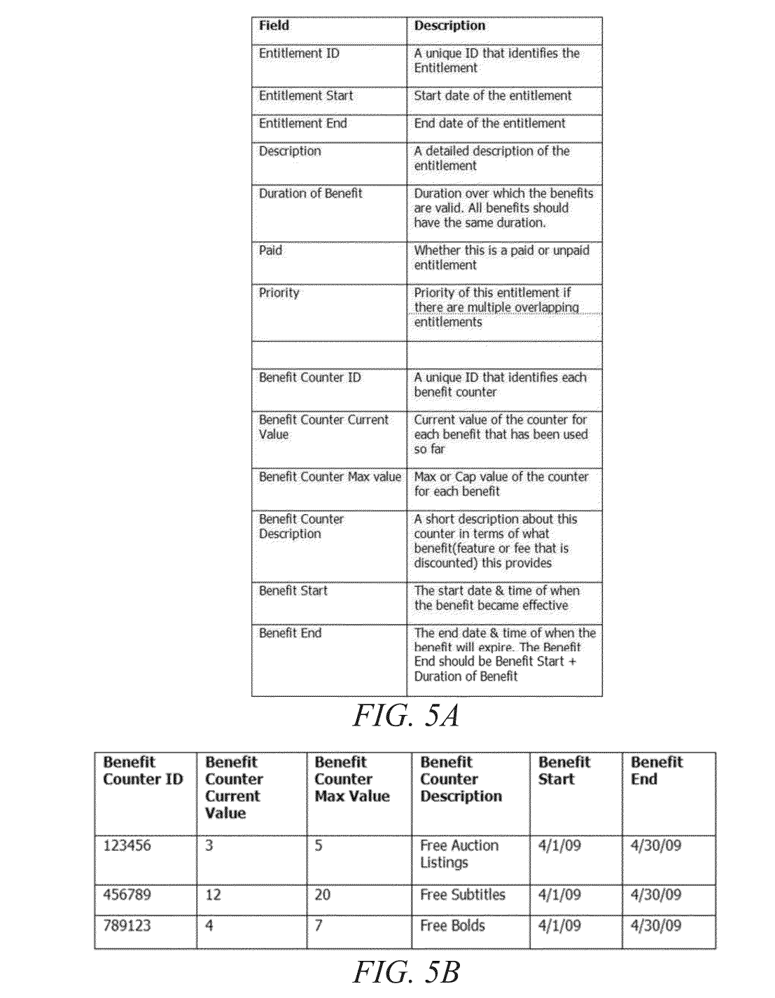

FIG. 5A is a table depicting an example data structure for an entitlement, according to an example embodiment. In an example, the table depicted in FIG. 5A depicts an example structure of information that may be associated with an entitlement.

For example, the entitlement may specify that casual sellers will get 5 IF Free Auction listings+20 Free Subtitles+7 Free Bolds every 30 days. This entitlement may be represented as having an Entitlement ID of 1, an Entitlement Start Date of Apr. 1, 2009 00:00:01, an Entitlement End Date of Dec. 31, 2010 23:59:59, a Description of “Casual sellers will qualify for 5 IF Free Auction listings+20 Free Subtitles+7 Free Bolds every 30 days,” a Duration of Benefit of 30 days, a Paid value of FALSE, and a Priority of 1.

FIG. 5B is a table depicting various examples of tracking entitlement benefit usage, according to an example embodiment. The entitlement may have multiple distinct benefits. The usage of each benefit may be counted separately, as depicted in FIG. 5B.

Multiple benefits may have the same benefit End date even if the benefits are first used at different start dates. The end date of the first benefit that is used may be applied to other benefits that are used later. For example, if a user lists an Auction item on April 1 with no features selected and then on April 3 lists another item with subtitle and a third item with bold on April 4, each of the three benefits may have an end date of April 30.

### Conceptual Framework

The Entitlements Infrastructure may consist of two major areas, the back end (BE) and front end (FE) and surrounded by a well defined process and tools when fully implemented. The BE may have common infrastructure components to support multiple and different entitlements. The FE may provide support for communicating the current status of entitlements and also any user initiated mechanism to enable entitlements. Each new entitlement may be implemented as a separate project. It may have the FE and BE pieces well defined. Most of the changes may be on the FE and leverage as much of the BE infrastructure as possible.

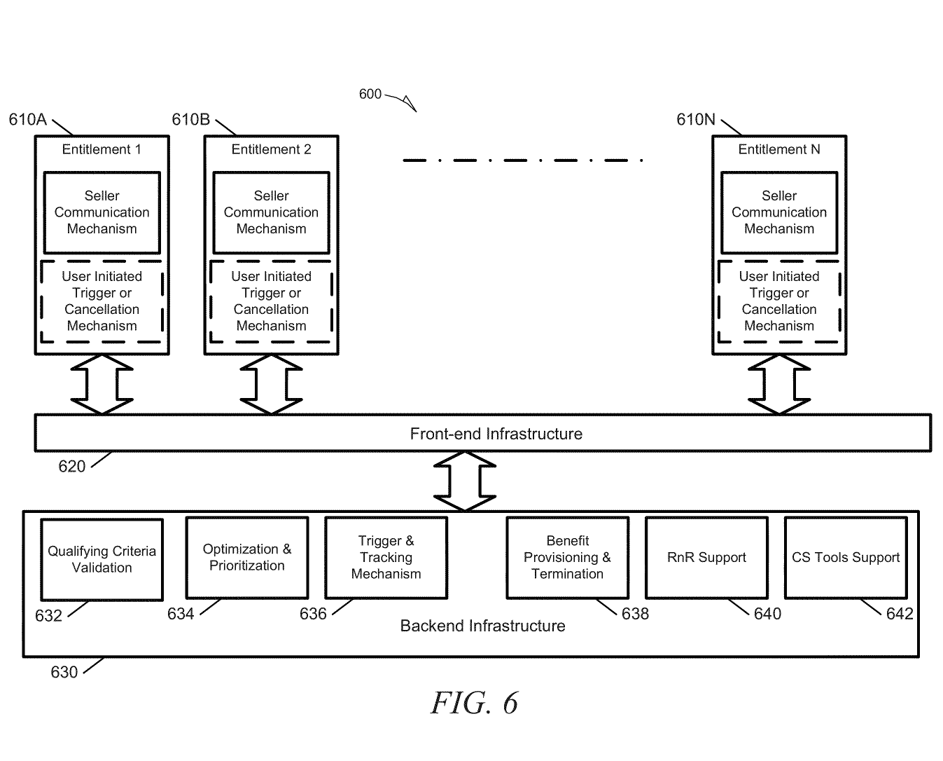

FIG. 6 is a block diagram illustrating an example system architecture for managing complex entitlements, according to an example embodiment. A high-level conceptual structure of an example embodiment of the Entitlement Infrastructure is shown in FIG. 6. In an example, a system 600 can include a plurality of entitlements 610A . . . 610N (collectively referred to as entitlements 610), a front-end (FE) infrastructure 620, and backend (BE) infrastructure 630. In an example, the backend infrastructure 630 can include a qualifying criteria validation module 632, a optimization and prioritization module 634, a trigger and tracking mechanism 636, a benefit provisioning and termination 638, a recover and reconciliation (RnR) support module 640, and customer service (CS) tools support 642.

The BE infrastructure 630 may consist of components that may enable the setup and configuration of the qualifying criteria (qualifying criteria validation module 632), specify when to trigger the provisioning of entitlement, keep track of the count and cap or limits of the benefits, facilitate application of benefits, or make sure the benefits are valid only over the specified time period.

Qualifying criteria validation (via the qualifying criteria validation module 632): the backend may check whether the party meets the qualifying criteria or not (e.g., whether the party part of a predefined list or the party is subscribed to a particular entitlement or is the party qualified as a volume seller of a particular level (e.g., an eBay Silver level PowerSeller).

Optimization or prioritization (via the optimization and priorization module 634): the backend may provide optimizations or prioritizations based on pre-defined rules especially when there is overlap between entitlements and RTPs. If there is an overlap between entitlements and RTPs then entitlements may take precedence over RTPs even if RTPs offer better prices. However, after the max or cap value of the entitlement is reached the party may qualify for RTP pricing. For example, the entitlement may offer the seller 100 subtitles at 10 cents each per month. If an RTP of 5 cents subtitle is running during this time and the seller hasn't reached the 100 subtitle limit yet, the next listing with subtitle may have the entitlement price of 10 cents instead of the RTP price of 5 cents. After the seller has exhausted all the entitlement benefit the RTP promo price may be applied. Multiple overlapping or colliding entitlements for the same fee type or feature may be handled in following way. The entity offering the entitlement may specify the priority for each entitlement whether it's paid or unpaid. The priorities may be sequential values from 1 to N, where 1 is the lowest priority and N is the highest priority. Paid entitlements may take precedence and may be applied first; then any unpaid entitlements may be applied. If two entitlements have the same priority, then the entitlement that will end sooner may take precedence and be applied. For example, a first entitlement, E1, may offer 10 IF Free listings and may end on May, 30, 2009. A second entitlement, E2, may offer 5 IF Free listings and may ends on Jun. 15, 2009. Assuming E1 and E2 have same priority, if the seller is listing an item on May 29, 2009, then E1 may be applied first until it is exhausted; then E2 may be applied.

Trigger or tracking mechanism 636: The trigger or tracking mechanism may be user initiated or system initiated. A user-initiated trigger or tracking mechanism may relate to a user or the party taking an action to initiate the entitlement (e.g., a user subscribing to a subscription based entitlement). A system-initiated trigger or tracking mechanism may relate to the networked system 102 qualifying the party for the entitlement (e.g., the seller reaches a certain volume level or an entitlement is given to casual (non-business) sellers. In both cases, when the party takes the action explicitly or qualifies implicitly, the party may reach a trigger point and qualify for the benefit.

Benefit provisioning or termination (via the benefit provisioning and termination module 638): The trigger or tracking mechanism 636 may indicate when the benefits should be provisioned. A provisioned benefit may be for a defined time period (e.g., the party qualifies for 10 Free Subtitles that is valid from December 1 thru December 31). In general, there may not be two or more benefits for the same entitlement with the same date range. In general, an order in which benefits are applied may be guaranteed. For example, assume the seller qualifies for an entitlement offering 100 IF free Auction listings per month. If the seller lists the auctions in a particular order (e.g., 200 auctions from high to low price), the networked system 102 may not guarantee that the first 100 auctions from seller's point of view will get 0 IF. In general, if the seller has exhausted all benefits for a particular time period, then the seller may not get additional further benefits. In this case, an appropriate rack rate may be applied.

Recovery or reconciliation support (via RnR support module 640): The system may support an easy or flexible mechanism for recovery of a counter or reconciliation of benefits for affected items, as described in further detail below.

CS tools support 642: An entitlement, whether it's paid or unpaid, may be exposed to CS tools so that it's easy, intuitive, or seamless for Customer Support teams to understand. The entitlement parameters available at user and item levels may be exposed, as described in further detail below.

The FE infrastructure 620 may include a party communication mechanism or a user-initiated trigger or cancellation mechanism. The party communication mechanism may enable a specifying of how information about the entitlement is communicated to parties. The information may include current qualifying status, current benefit status related to selling an item (e.g., eBay's Sell Your Item (SYI)), other status related to selling the item (e.g., information from eBay's Seller Dashboard), account status (e.g., eBay's View Account Status (VAS)), an invoice, e-mail addresses, Help pages, etc. The user-initiated trigger or cancellation mechanism may specify how parties initiate the entitlement process if it is available to them (e.g., subscription enrollment) or terminate the process (e.g., subscription cancellation).

### Counters

A counter may be used to keep track of the usage of the benefit of the entitlement. The counter may indicate the count of the listings that meet the benefit criteria or utilize the benefit. Each benefit may have a separate counter associated with it. For example, the counter may indicate the number of free listings used so far by a seller who is eligible for 100 free listings during a month. The entitlement may be associated with a user or party. In general, the counter may be used primarily in the context of a listing to keep track of the benefits. For example, assume a user qualifies for 1000 free listings with Anchor store subscription every month. In this case whenever an item qualifies for free IF (e.g., it's the nth listing during that month and n<=1000), the entitlement counter may be incremented to reflect that the benefit has been utilized. The benefit qualification rules may be based on the listing attributes. If an item meets the benefit criteria based on the item's attributes and the time of the listing is within the entitlement period then the particular benefit counter may be updated. In general, the counter may usually be incremented or additive and rarely, if ever, decremented. The counter may have a lifecycle. Furthermore, a counter may be created, used, terminated, or recycled. The counter may have a start date and time or an end date or time. In general, the counter may be valid only during that time period between the tart date and time and the end date and time. Beyond the end date and time, the counter may not be applicable and may not be valid. For example, assume the user qualifies for 1000 free listings with Anchor store subscription every month. In this case, whenever a new listing is listed and a counter does not exist for that period, a new counter is created that has start date the beginning of the month like Jan. 1, 2009 and end date is end of the month Jan. 31, 2009.

When a new counter is created, the count value may begin at 1. In general, for a given entitlement, there may not be two active counters at the same time. The counter may have a maximum or cap value. In other words, benefits may be capped at a certain maximum value and the counter may need to count only up to the maximum value. The value of the counter after the maximum value may not make any difference in terms of pricing. For example, assume the user qualifies for 1000 free listings with Anchor store subscription every month. In this case, the counter may need to count up to value 1000 and, after that, the value may not make any difference from the pricing point of view. In this case, beyond 1000 listings, any new listings coming along may be charged the standard rack rate. There may be many counters with different benefit criteria or effective dates in the system. The user may qualify for multiple entitlements simultaneously and hence there may be multiple counters applicable to a listing from the user. Any introduction or setup of a new counter in the system may be done via configuration or rule deployment and preferably may not require any code rollout or tied to a train. Thus, the setup of new entitlements may be deployed anytime and also recovery or reconciliation may be initiated anytime there is a problem.

### Global Availability

The backend infrastructure 630 may be built so that it can be leveraged for multiple marketplace sites associated with the networked system 102. For example, the backend infrastructure 630 may be associated with marketplace sites for a particular geographic location (e.g., the United States), for a particular product (e.g., vehicles or parts and accessories for vehicles), or international sites. The front-end entitlements may be specific to a country or site. Any country or site that wishes to offer entitlements on their site may implement a separate concept or project on the front-end. In most cases this may not involve changes to the back-end infrastructure, depending on unique requirements related to each entitlement. An entitlement implemented for a site or country may be enabled or leveraged to the maximum extent possible on other sites or countries with minimal changes required.

### RTPS and Entitlements

RTPs may be running in parallel with entitlements. In an example, entitlements may take precedence over RTPs if there is an overlap even though it may not be favorable to the seller from a pricing perspective. If the entitlement count has been exhausted or reached the max or cap value, then the RTP pricing may take effect and apply to the listing. For example, assume an entitlement offers 100 subtitles at 10 cents each per month and an RTP offers subtitles at five cents each on December 1^{st}. Furthermore, assume the seller lists an item on December 1st with a subtitle and his entitlement count is 99. In this case, the seller may get the entitlement price of 10 cents and his entitlement count may be incremented to 100. If the seller lists another item after that, he may get the RTP price of 5 cents because the seller has exhausted the entitlement. In certain examples, RTP pricing can take precedence over entitlements. In yet other examples, transactions can be evaluated to against RTPs and entitlements with the most beneficial RTP or entitlement being applied to any particular transaction.

### Feature Bundles

An entitlement may be offered at a feature level, a bundle level, or both. When an entitlement is offered at the feature level (e.g., 50 free subtitles or 10 free bolds, etc.), or if the listing has selected the feature or it qualifies for the feature as part of the entitlement benefit criteria, then the listing may be counted towards the entitlement or the appropriate counter may be incremented. If the item is revised later or the listing with feature (e.g., with Subtitle) is upgraded to a feature bundle (e.g., with Value Pack), the item may count towards the feature entitlement or a full fee for the Value Pack may be charged if there is no entitlement on the Value Pack. If an entitlement is offered at the bundle level (e.g., Value Pack) then it may also count towards the bundle entitlement in addition to the feature (e.g., Subtitle) entitlement. The count for the feature (e.g., Subtitle) entitlement may not be decremented in this case. If a bundle (e.g., Value Pack) is applied at first on the listing then the feature level entitlement may not be counted when the entitlement is offered at the feature level (e.g., Subtitle) only and not at the feature bundle level. Entitlements may support RTP-type feature bundling. Furthermore, entitlements may support feature rebalancing between IF and FVF.

### Listing Creation Flows

During a flow for listing an item (e.g., during eBay's SYI flow), a set of listings may be checked to see if they meet the conditions of benefit criteria (entitlement benefit application rules) of one or more entitlements. If a listing meets the conditions, then the counter(s) associated with the qualifying entitlements may be incremented and the corresponding value assigned to the listing. For every counter associated with a benefit, there may be a rule or criteria associated that determines when to increment the counter. When the criteria are met, the counter may be incremented and the listing may become the Nth one to meet the condition. As generally every counter counts listings, it may be incremented maximum once per listing. If the listing meets multiple but non-overlapping entitlements criteria, then each of the qualifying counters may be incremented and updated on the listing. For example, an entitlement may offer 200 free Auction or Fixed Price listings, 50 free Subtitle upgrades, 10 free Featured First upgrades per month. Furthermore, assume that if a listing is listed in Auction format with Subtitle and Featured First features, it meets all three entitlements criteria if the cap value hasn't been reached. In this case, all three counters associated with the three benefits may be incremented. During SYI flow, all the entitlements the seller is eligible for may be messaged using custom messaging for insertion fees and using an RTP messaging framework for features. In generally, it may be messaged only if the cap or maximum value hasn't been reached yet for each benefit counter or the current listing still qualifies for the entitlements. On a listing creations page, a listing flow may determine whether this listing qualifies for any entitlements based on the listing options selected. The listing flow may evaluate if the listing meets the benefit criteria of any of the entitlements. If an entitlement has Insertion Fees as one of the benefits and the current counter value is equal or less than the Max counter value then a message may be displayed at the top of the page, such as a message having the following format:

“[Information Icon][Placeholder for custom message for each entitlement]”

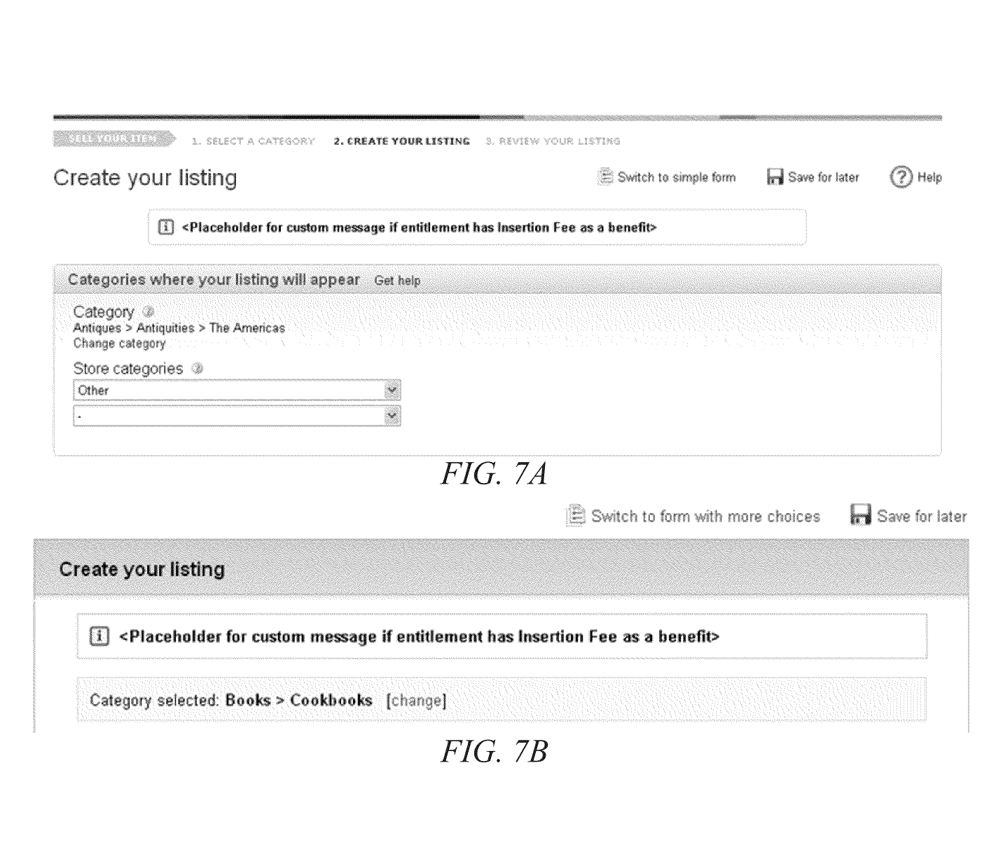

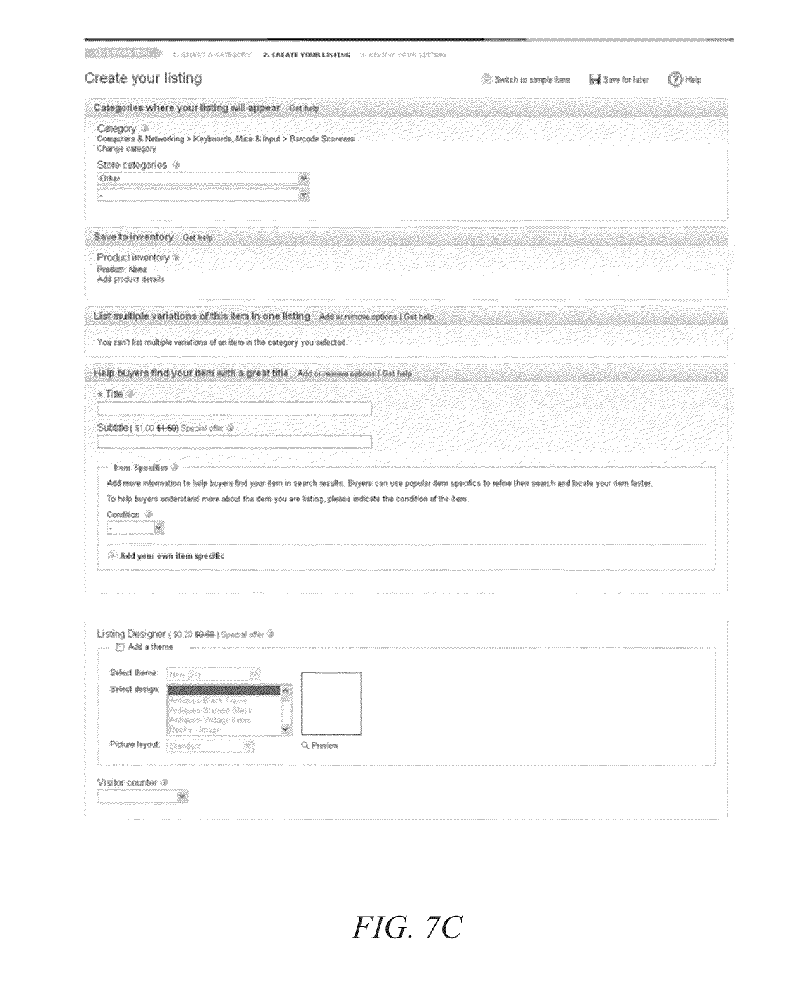

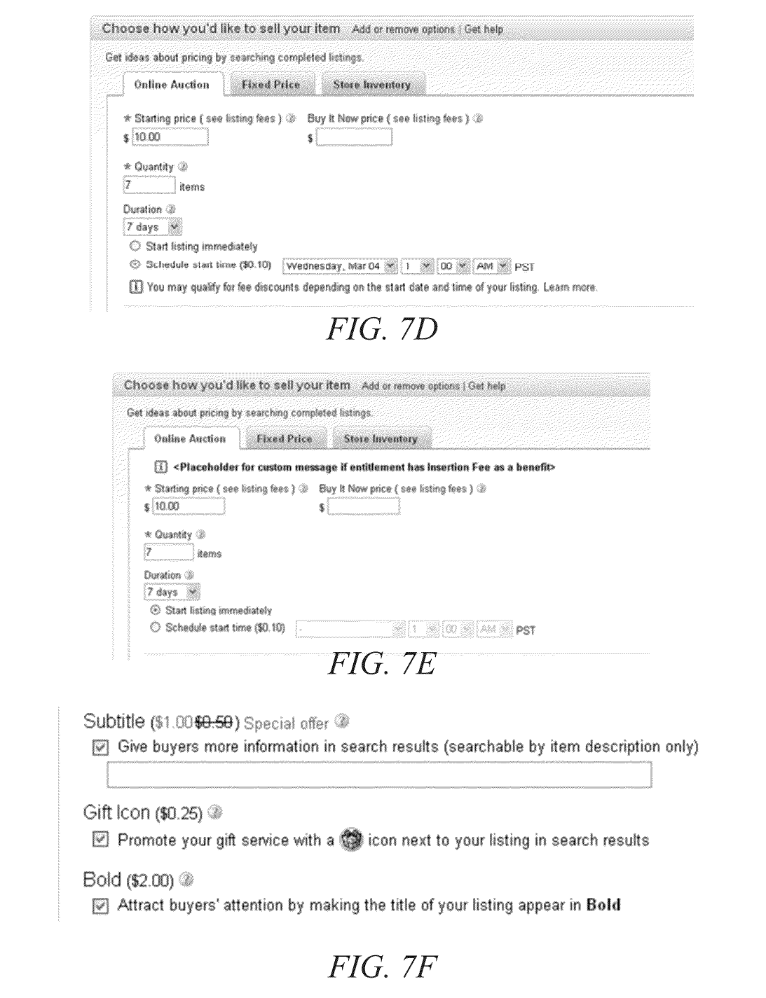

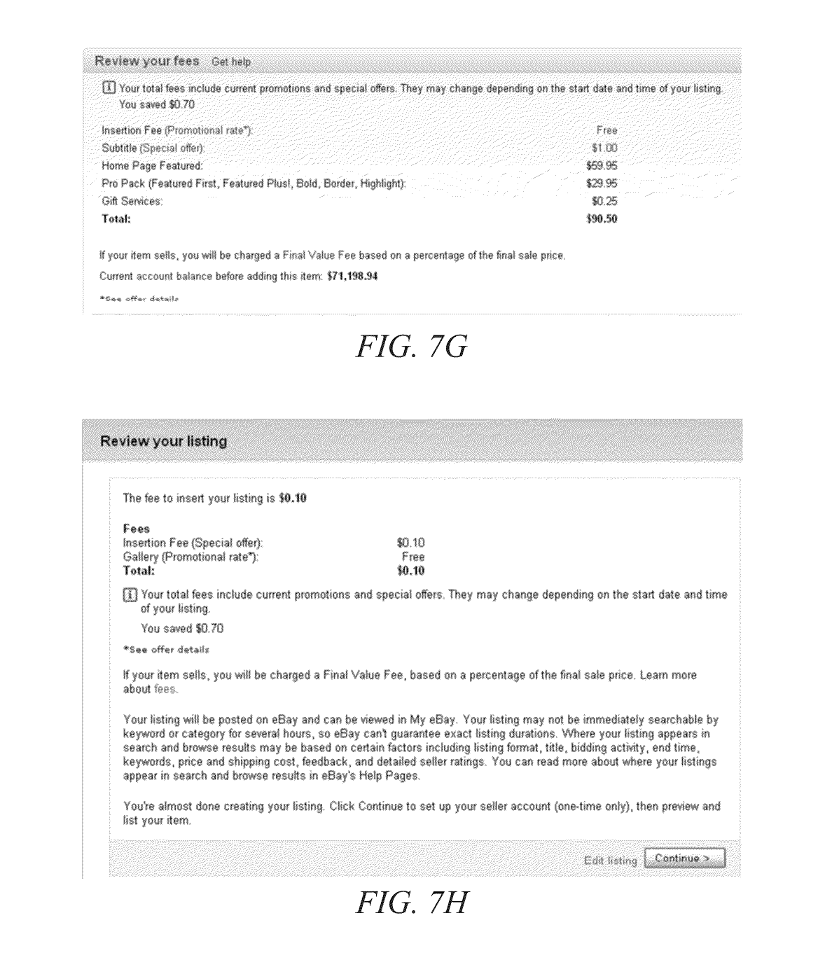

FIG. 7A-7H are user interface screens illustrating various examples of messaging related to entitlements within a network-based system, according to an example embodiment. FIG. 7A depicts an example of a placement of the message on an example listings creation page (that is, a listing page in eBay's SYI flow).

FIG. 7B depicts an example of a placement of the message on another example listings creation page (that is, a listings page in eBay's Easylister flow).

The placeholder message may be defined or unique for each entitlement. In some examples, the message may be limited to five lines maximum. In an example, the message may accommodate HTML formatting, including defining image tags or HTML links. In an example, if the entitlement does not have Insertion Fees as a benefit, then this message may not be displayed at the top of the listings creation page. In an example, if a listing meets the criteria or the entitlement offers feature benefits (e.g. Subtitle is free), the message may include the entitlement price, the rack rate with strike through next to or over it, or a message indicating that an offer is a special offer. For example, the message may include the phrase “Special offer.” FIG. 7C shows an example listings creation page specifying entitlement prices at a feature level, according to an example embodiment.

In an example, for scheduled listings, an informational message having the following format may be displayed:

“[Information Icon] You may qualify for special offers depending on the start date and time of your listing.” This message may be applicable to some example listing creation flows (e.g., eBay's Sell Your Item flow), but not others (e.g., eBay's Easylister flow). In general, this message may not be shown when the scheduled listing option is not selected or the listing is not qualified for an entitlement.

FIG. 7D shows an example of a custom message being displayed scheduled listing page in an example listing creation flow.

When a user switches from one format tab to another (e.g. from an Auctions to a Fixed Price tab) or returns to the format that qualifies for an entitlement, then a message having the following format may be displayed above the Start Price:

“[Information Icon][Placeholder for custom message for each entitlement]”

In an example, this custom message may be the same custom message that is shown at the top of a previous page (FIG. 7C) in the listing creation flow. In the example depicted in FIG. 7D, the message may be applicable to some example listing creation flows (e.g., eBay's Sell Your Item flow), but not others (e.g., eBay's Easylister flow). In general, this message may be shown only if the listing hasn't exceeded the maximum counter value for Insertion Fees or meets qualifying conditions. FIG. 7E shows an example of a custom message being displayed when the user switches from one format tab to another.

The listings creation flow may include a page for reviewing a listing. FIG. 7F shows an example page for reviewing the listing that includes a special offer. On the page depicted in FIG. 7F, the listing flow may determine whether a listing still qualifies for any entitlements based on the listing options selected. If an entitlement offers a feature benefit (e.g., it offers a Subtitle for free), the page for reviewing the listing may show the entitlement price, the rack rate with strike through next to or over it, and a message. The message may include the phrase “Special offer.”

In an example, a page in the listing creation flow may include a section for reviewing fees associated with listing. FIG. 7G shows an example page of an example listing creation flow that includes a section for reviewing fees for RTPs and entitlements. The section may display the entitlement benefit insertion fee or the entitlement benefit feature fees for applicable features. If an entitlement offers an insertion fee benefit (e.g., the entitlement offers IF for free), then the section should use the entitlement benefit fee to calculate the total fees. A message having a format similar to the following message may be displayed in the section if the listing applies both RTPs and entitlements:

“Your total fees include current promotions and special offers. They may change depending on the start date and time of your listing.”

A further sentence of the message may state something similar to “You saved: $0.70,” where the savings value may include savings from both RTP and entitlement discounts together (that is, the combined savings from both programs). Any fees that have entitlement benefits applied may have an associated message including the text “(Special offer)” appended to it. Any fees that have RTP rates applied may append an asterisk (“*”) at the end of the “promotional rate” or message text. The section may include the text “*See offer details,” where “offer details” may be a link that points to a Help page (e.g., “http://pages.ebay.com/sell/terms-conditions/index.html”). In general, such a message may be shown only when the item qualifies for an entitlement.

FIG. 7H shows another example of page of another example listing creation flow that includes a section for review fees for RTPs and entitlements.

In an example, on a page of the listing creation flow, when, for example, a listing is submitted and if the cap value is reached in the meantime (for example, when two additional auction listings come from the same seller via API or bulk flows) or an entitlement expires, an error message may be displayed at, for example, the top of the page. The error message may be similar to an error message displayed whenever a price changes during a listing submission. If the listing is successfully listed with entitlements then it may have applicable entitlement benefit counter values incremented and associated with the item. If the user or party is no longer eligible for any entitlements (e.g., the user is disqualified or voluntarily cancels the entitlements (for example, via subscription management)) then any new listings going forward may be charged at the regular rack rate and these listings may not be eligible for any entitlements.

In an example, if a user within a particular listing creation flow saves a draft of an entitlement qualifying listing, then the benefit counters may not be incremented. When the user opens the draft of a potential listing, the listing creation flow may re-determine whether the listing qualifies for entitlements. If the seller lists an item in two categories, the item may be qualified for entitlements based only on the primary category. The second category may not qualify for entitlements and may typically be charged the regular fees. Also the benefit counters may be incremented only once for listings if they qualify.

In certain examples, there can be three cases for listing an in two categories. Case1: Assume both categories have qualifying entitlements (e.g., entitlement1 for Baby and entitlement2 for Clothing). Let's say Clothing is category 1 (primary) and Baby is category 2 (secondary). In this case, entitlement1 (pertaining to Clothing) may be applied. The entitlement1 counters may be incremented and its fees may be applied. Even though Baby category has its own entitlement, it may not be applied in this case because it's the secondary category.

Case2: Assume one category (e.g., Baby) has an entitlement and another category (e.g., B&I (tractors)) does not have an entitlement. Let's say Baby is category 1 (primary) and B&I (tractors) is category 2 (secondary). In this case, entitlement1 (pertaining to Baby) may be applied. The entitlement1 counters may be incremented and its fees may be applied. B&I(tractors) may be charged regular IF fees.

Case3: Assume one category (e.g., Baby) has an entitlement and another category (e.g., B&I (tractors)) does not. Let's say B&I (tractors) is category 1 (primary) and Baby is category 2 (secondary). In this case, B&I (tractors) may be charged regular IF fees because it has no entitlement. Baby may also be charged regular IF fees because it's the category2 (secondary) even though it has an entitlement. No entitlements may be applied in this case.

In some examples, Second-chance offer (SCO) items may be applicable to Auctions and may be supported by entitlements. For example, the seller may create SCO items if there are multiple bids on an auction item and the highest bidder does not want to enter into a transaction. In this case, the Seller may send SCO items to the remaining bidders on the listing. The seller may potentially send an SCO item to each bidder and each of these items are unique per bidder. If a bidder buys the SCO item, then the benefit count values from the parent or the original item may be used to calculate the FVF for this item. The count from the parent item may also be associated with the SCO item. If more than one bidder buys each of their SCO items, then for each SCO item, the benefit count value from the parent item may be used to calculate the FVF. Also, the count from the parent item may be associated with each of the SCO items. In general, if the SCO items are not bought, then changes may not be made to the SCO items.

### Listing Revision Flows

In an example, entitlements typically apply only to new listings that are listed after the entitlements are active for the appropriate party. In other words, entitlements may not typically apply to listings that were listed prior to the entitlements that the seller is eligible for. For example, assume a seller has some existing listing I1 without subtitle and he does not have any entitlements. The user then may be eligible for an entitlement. If the seller then revises item I1 to add subtitle later, this listing may not qualify for the entitlement benefit. This listing may be charged the full subtitle price. In contrast, if a seller lists a brand new item with subtitle after subscribing to the entitlement, the subtitle may be free for this item if the cap value hasn't been reached. The flow for revising an item listing may be slightly different for entitlements that have Insertion Fees as a benefit instead of Feature Fees. The following use cases describe an example embodiment of application of entitlements to general listing revision behaviors, including general changes, user (or party) attribute changes, and item attribute changes.

In certain examples, with respect to general changes, IF-related entitlements may be honored only when the item is first listed. Not later during the revision even if the item qualifies because high water mark (HWM) logic applies. Feature-related entitlements may be honored during the revision as long as the listing qualifies. Once a listing is unqualified, both IF and features entitlements may no longer apply. However, in certain examples, benefit counts previously applied may remain and may not be removed or decremented. For the fees, the HWM logic applies.

With respect to user attribute changes, if a user is eligible for an entitlement and applied the entitlement to an item at listing time, the entitlement may be honored on that item during a revision even if the user's attributes at revision time do not qualify the user for the entitlement anymore. If the user is eligible for an entitlement and did not apply an entitlement to an item at listing time, the entitlement's feature benefits may be applied on that item during the revision if the user's attributes at revision time qualify the user for that entitlement. If the user is not eligible at listing time but later became eligible at RYI time. In this case it should not apply the entitlement to the revised listing.

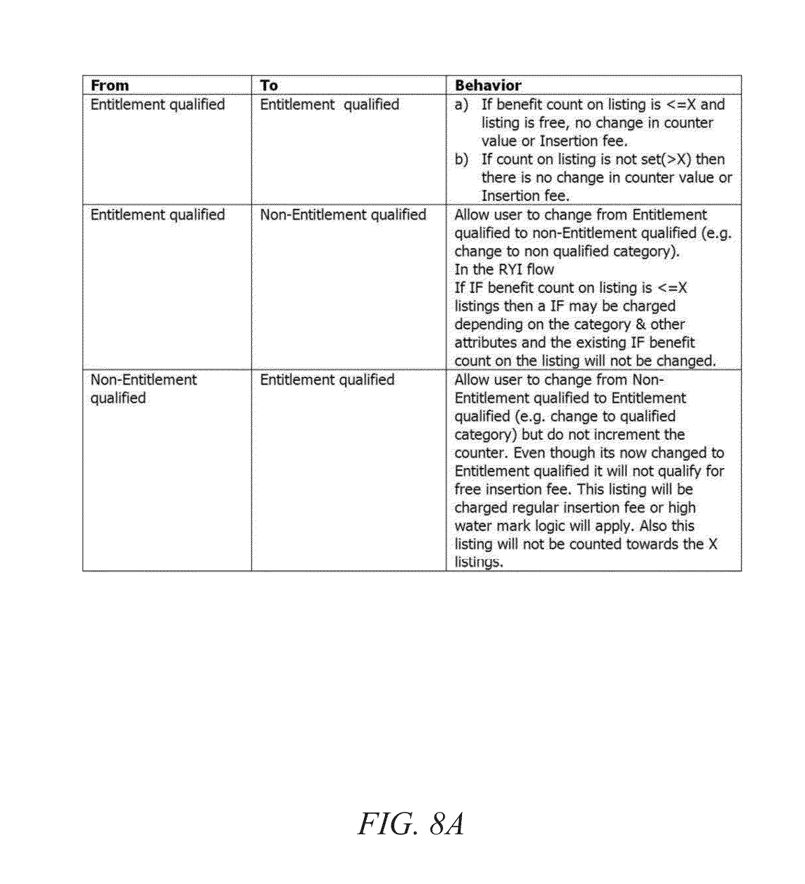

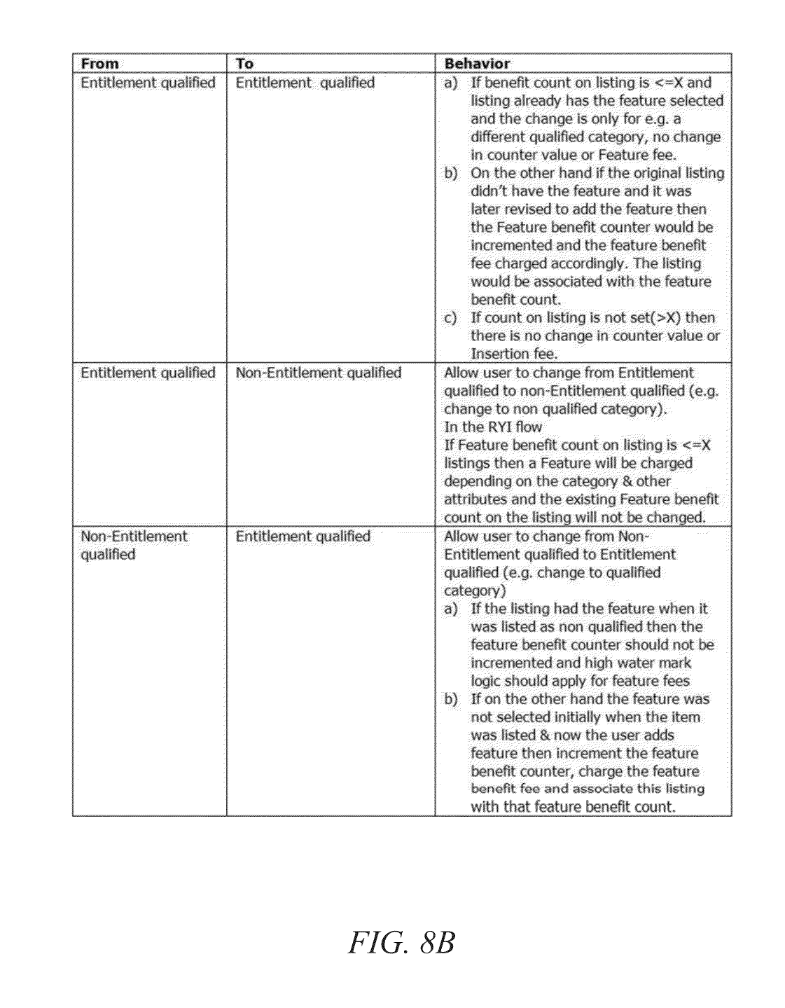

In an example, with respect to item attribute changes, if an item already has an entitlement applied at listing time, the entitlement on that item may be honored during a revision if the user completes the revision and there is no change to qualifying item attributes during the revision. At revision time, if the item attributes are changed, then the applied entitlement may no longer be valid. In other words, the entitlement price may not be applicable anymore or the entitlement counters may not be changed. Even if an item did not have an entitlement applied at listing time, entitlement's feature benefits may be applied at revision time if the item attributes still qualify the item. FIG. 8A depicts example revision behaviors for example IFs, where X is the maximum or cap value for the benefit.

FIG. 8B depicts example revision behaviors for feature fees, where X is the maximum or cap value for the benefit.

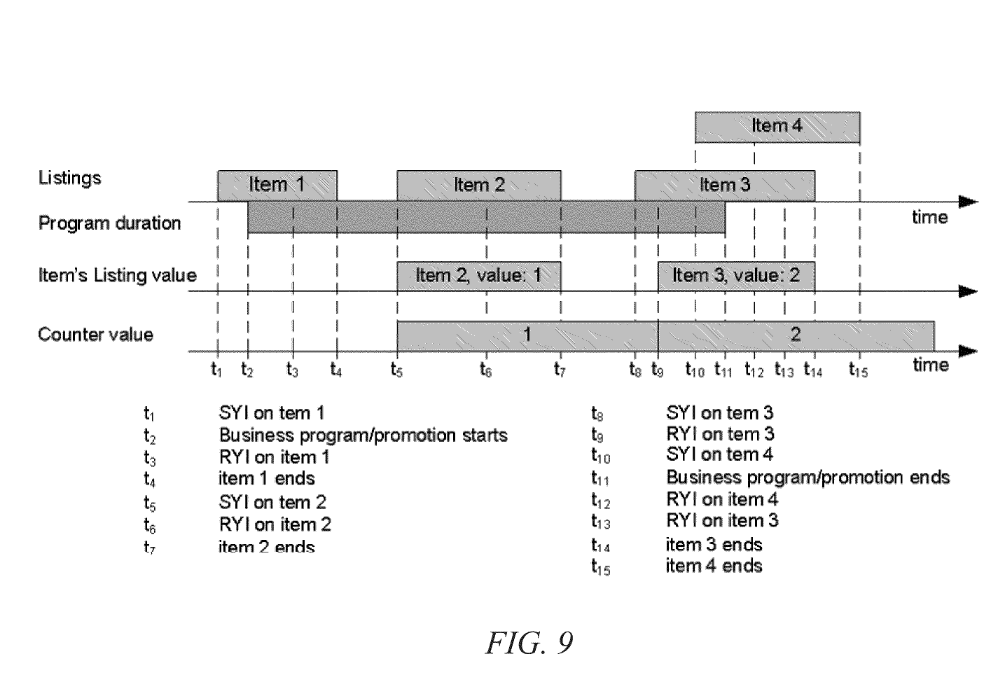

In an example, when an entitlement is announced to the users, the entity offering the entitlement may specify a start date and an end date. This means that items listed after the entitlement start date and meeting some qualifying conditions will get a special pricing. Internally this means that all the listings with start date greater than the entitlement start date and meeting the benefit criteria will qualify. FIG. 9 is a timeline illustration depicting application of an example entitlement to various transactions over time, according to an example embodiment. More specifically, FIG. 9 depicts the behavior of an example embodiment of the networked system 102 with respect to entitlements during listing creation (e.g., Sell Your Item (SYI)) and revision (e.g., Revise Your Item (RYI)) flows.

With respect to the example depicted in FIG. 9, Item 1 did not increment the value of the counter as during SYI (t1), the entitlement is not available. Item 2 qualifies to increment the counter during SYI (t2) and the entitlement is also available at that time. So, it creates a brand new counter with a value of 1. Item 2 becomes the first listing, which meets all the counter qualification conditions and its listing value is 1 as well. Item 3 did not qualify to increment the counter during SYI (t8). During RYI at t9, it qualifies. At that time, the entitlement is still active and it increments the counter to value 2. Item 3 becomes the second listing, which meets all the counter qualification conditions and its listing value is set to 2. During t13, item 3 gets revised again. At this time the entitlement has ended. As the item already incremented the counter at t9, it keeps its value. This is still the 2nd item, which met the counter's qualification conditions. Item 4 did not qualify to increment the counter during SYI (t10). It did qualify during RYI (t12). At this time though, the entitlement has already ended (t11). This is the reason item 4 does not increment the counter and does not have listing value for this counter.

In an example, if a user is no longer eligible for any entitlements (e.g., the user doesn't qualify or voluntarily canceled any entitlement (e.g., via subscription management)), then any listing that was listed during the entitlement period and is revised post-entitlement period may not qualify for any additional entitlements because they are no longer valid during revise period and the listing may honor those entitlements that were already applied at the time of listing.

### Relisting and Selling Flows

During a relisting of an item, if the item qualifies for any entitlements, then the entitlements may be applied. It may be as if a new item is being listed. Similarly, during a selling of an item, if the item qualifies for any entitlements, then the entitlements may be applied. Again, it may be as if a new item is being listed.

### API Flows

Listing-related API calls (e.g., API calls to listing creation application(s) 218 and listing management application(s) 220) (e.g., APIs for adding a listing, adding a listing from a template, relisting an item, verifying an adding of a listing, revising a listing, verifying the revising of the listing, revising an item, revising a template, and so on) may support entitlements. In an example, for calls to such APIs, if the listing qualifies for an entitlement and there is no overlapping RTP running then the API may return a regular price (rack rate) even though the listing qualifies for an entitlement price. What this means is the API may not return the entitlement price even if the listing qualifies for the entitlement price. In an example, the API may also return an indicator specifying whether the listing qualifies for an entitlement benefit. For other APIs, when a listing qualifies for an entitlement and there is an overlapping RTP running, if an entitlement price is greater than an RTP price, the API may return the base price; otherwise, the API may return the RTP price. The API may also return an indicator that the listing may qualify for an entitlement benefit. For APIs relating to adding a listing, a response may include the price that was actually charged for Insertion Fee and Feature fees. In certain examples, if entitlement fees were charged, the entitlement fees may be returned. If RTP fees were applied then RTP fees may be returned. In some examples, an indicator may be returned that identifies the type of discount that was applied whether it was an entitlement or RTP at the fee level. In an example, an indicator may also be returned that specifies whether the listing qualified for an entitlement.

### Listing Tools

Listing tools, including tools or pages for adding or revising item listing in bulk (e.g., eBay's Selling Manager or Bulk Flows) or client applications (e.g., eBay's TurboLister) interacting with the networked system 102, may support entitlements, including the display of messages, such as the messages described above, relating to entitlements. In an example, when a listing tool is used to make bulk additions or revisions of item listings, the corresponding flow pages or user interfaces may be modified to show an entitlements message if at least one listing qualifies for an entitlement.

In certain examples, the listing tool may show the price returned by an API call to applications 120 and 122. The listing tool may further show an informational message (for example, at the bottom of a Review or Submit page) having a format similar to the following format:

“[Information Icon] Some of your listings may qualify for special offers.”

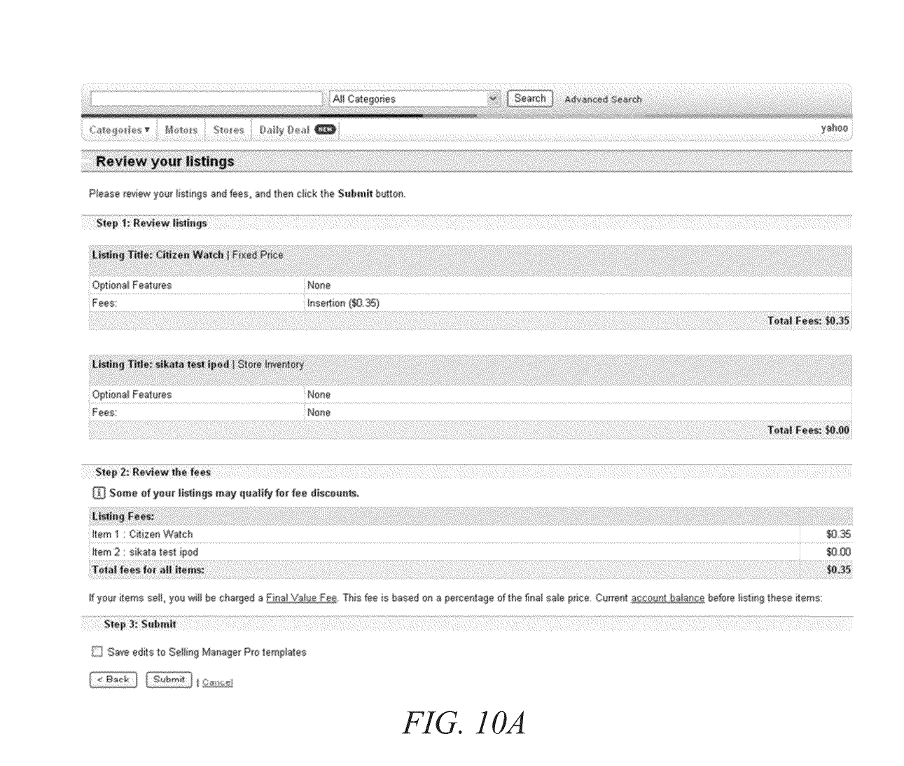

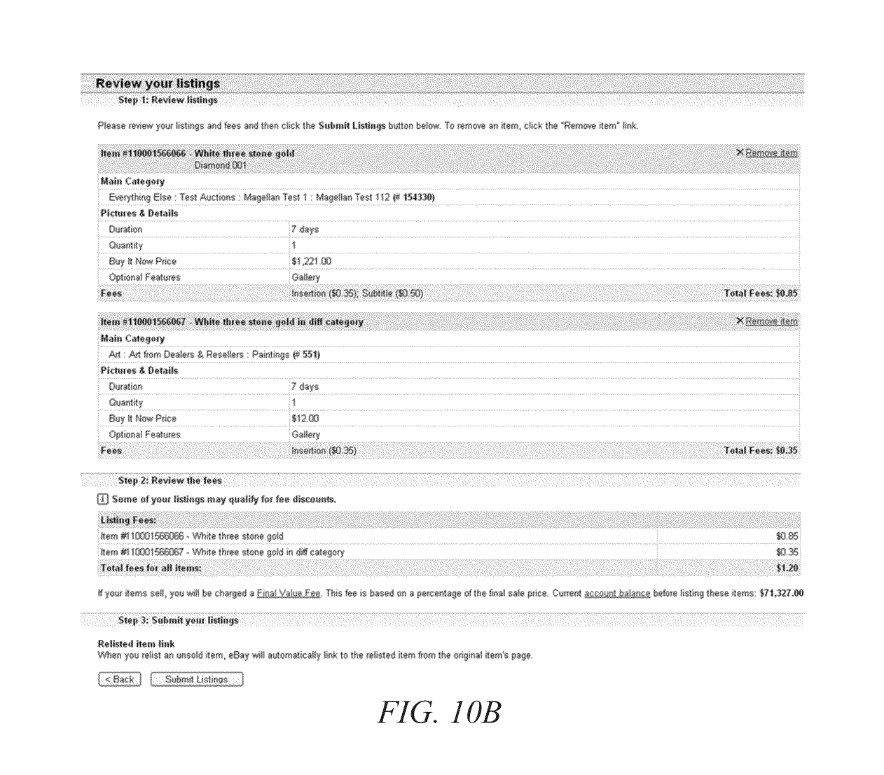

FIG. 10A-10B are user interface screens illustrating various examples of messaging related to entitlements within a network-based system, according to an example embodiment. FIG. 10A depicts an example of a message related to entitlements appearing on an example page for reviewing listings in a bulk editing flow. FIG. 10B depicts an example of a message related to entitlements appearing on an example page for reviewing listing in a bulk relisting flow.

In an example embodiment, a client application may show a similar informational message in a popup dialog box (e.g., a waiting to upload (before listing is uploaded) or activity log (after listing has been submitted) popup dialog box) if any of the listings being uploaded qualify for an entitlement. For example, the client application may display a message like the following message in a popup dialog box:

“If you qualify for additional special offers, they will be applied after you upload your items.”

In an example embodiment, the message may displayed only when a “Calculate Fees” or “Upload[All/Selected/to Selling Manager” option is selected.

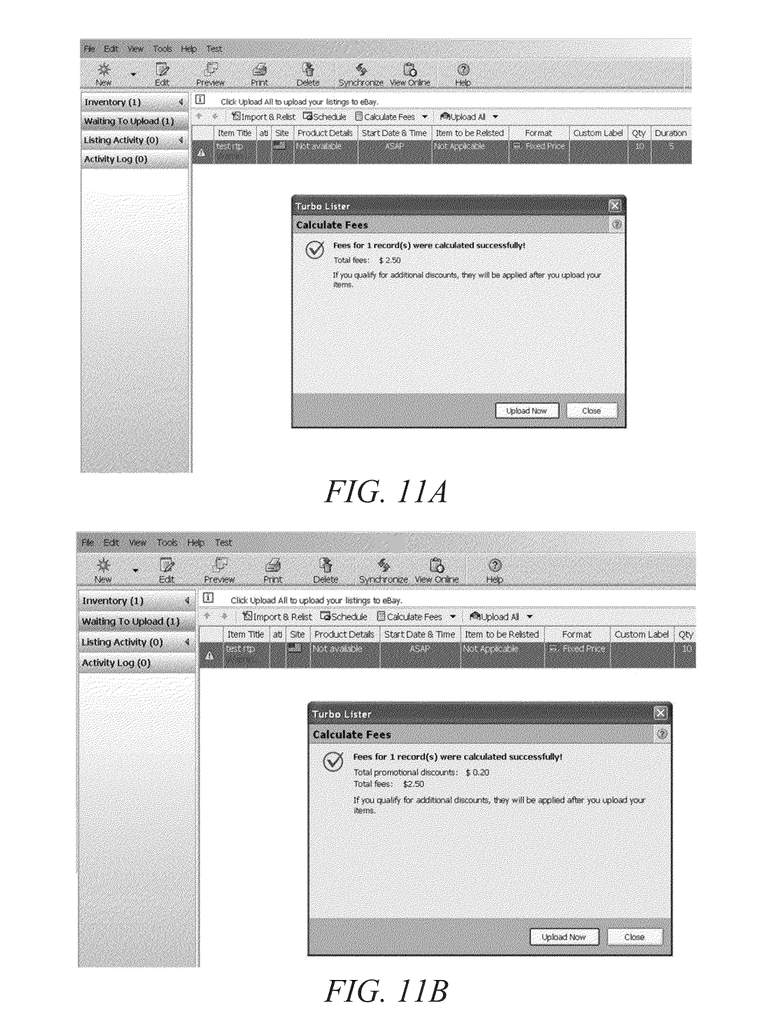

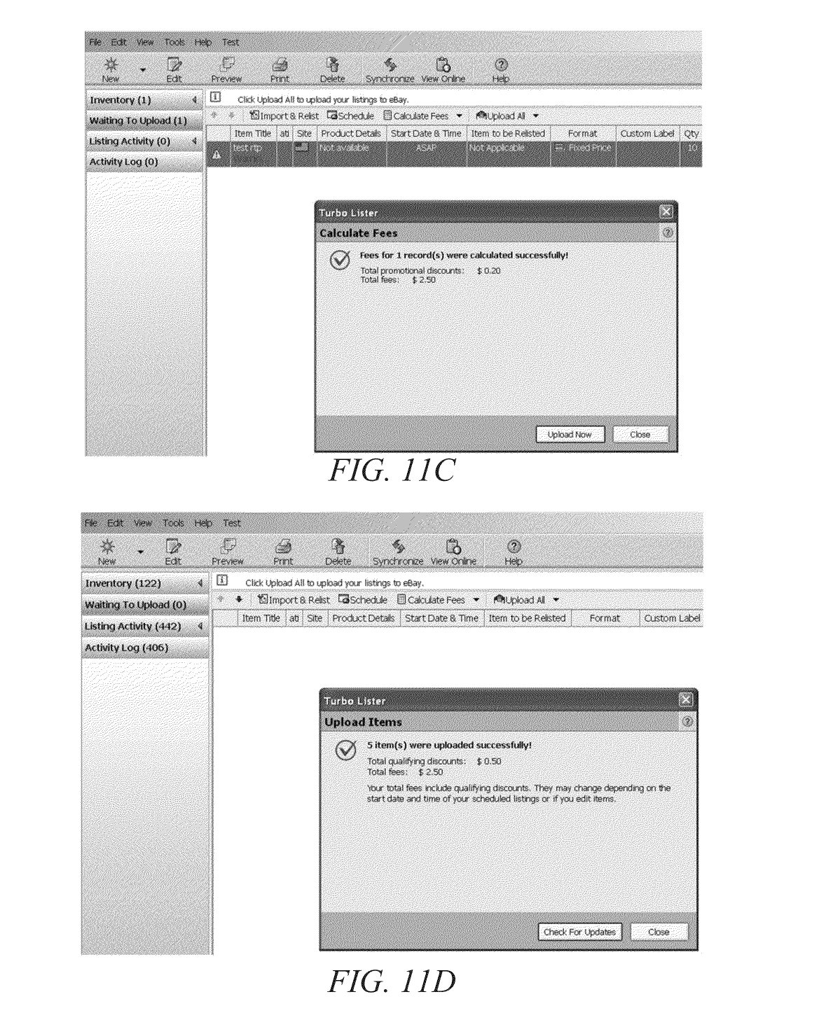

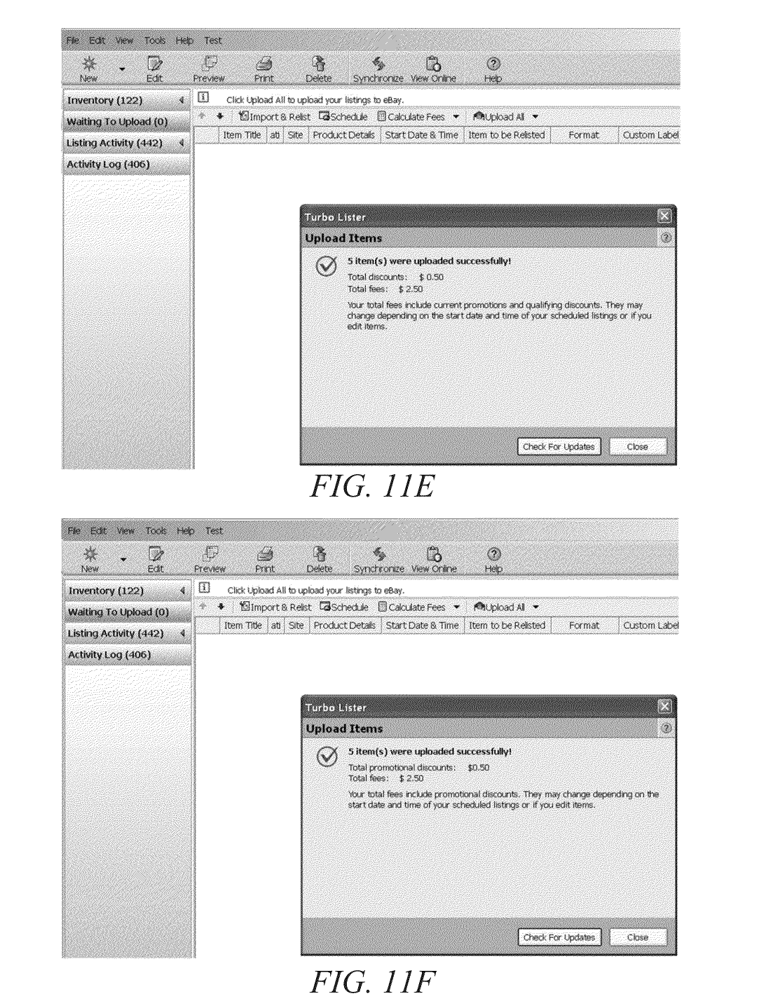

FIG. 11A-11G are user interface screens illustrating various examples of messaging related to entitlements within a third-party application accessing a network-based system 102 via an application programming interface 114, according to an example embodiment.

FIG. 11A depicts an example of a waiting to upload popup dialog box in a client application displaying a message related to entitlements only. The popup dialog box may display the total fees.

FIG. 11B depicts an example of a waiting to upload popup dialog box in a client application showing information related to entitlements and RTPs. The popup dialog box may show the total fees and total promotional discounts that these listings qualify for.

FIG. 11C depicts an example of a waiting to upload popup dialog box in a client application showing information related to RTPs only. The dialog box may show the total fees and total promotional discounts that these listings qualify for. The dialog box may not show an additional message.

FIG. 11D depicts an example of an after upload popup dialog box in a client application showing information related to entitlements only. The dialog box may show the total fees and total promotional discounts (the sum of entitlement discounts only) that these listings qualify for. The dialog box may also show the a message like the following message:

“Your total fees include special offers. They may change depending on the start date and time of your scheduled listings or if you edit items.”

FIG. 11E depicts an example of an after upload popup dialog box in a client application showing information related to entitlements and RTPs. The dialog box may show the total fees and total promotional discounts (the sum of entitlement discounts and promotional discounts) that these listings qualify for. The dialog box may also show a message like the following message:

“Your total fees include current promotions and special offers. They may change depending on the start date and time of your scheduled listings or if you edit items.”

FIG. 11F depicts an example of an after upload popup dialog box in a client application showing information related to RTPs only. The dialog box may show the total fees and total promotional discounts (the sum of entitlement discounts and promotional discounts) that these listings qualify for. The dialog box may also show a message like the following message:

“Your total fees include current promotions and special offers. They may change depending on the start date and time of your scheduled listings or if you edit items.”

### Renewal of Good Til Canceled Items

In an example, when Good Til Canceled (GTC) items are renewed, the benefit criteria may be re-evaluated against the listing to see if the listing qualifies for the entitlement benefit. If the GTC listing qualifies for the benefit, then the benefit counters may be incremented and benefit fees applied to this listing. Any previous benefit counter association of the GTC listing may not be active if the GTC listing is renewed. If the GTC listing does not qualify for the benefits (e.g., the seller has used up all the benefits during that period), then the standard rack rate may be applied. In this case, benefit counts may not be associated with the renewal.

### Customer Service (CS) Tools

Both paid and unpaid entitlements need to be exposed in CS tools at a user level and item level.

### Listing Violations

In an example embodiment, a counter associated with an entitlement may not be decremented under any circumstances. So, if a listing is ended prematurely either due to seller's actions or terms of service violations, or CS accidentally suspends or cancels a listing, the entitlement counter on a listing may not be decremented. Any credits the seller is eligible for may be issued to the seller but the entitlement counter may not be decremented or reset. In an alternative example embodiment, counters associated with an entitlement can, under certain circumstances, be decremented. In an example, customer service interfaces to the networked system 102 can include the ability to decrement an entitlement counter.

### Unpaid Items

If an item with an entitlement is flagged as AN unpaid item (UPI), then, in an example embodiment, the counter will not be decremented. Any fees the seller is eligible for may be credited to the seller per the UPI process.

### Wacko Limits

If a listing is pulled down due to wacko limit checks then it may be treated the same way as the UPI case above. In an example embodiment, a user may either be suspended or put on hold depending on the severity of their violations terms of service. On Hold: Because seller may not be able to list new items, any of the entitlements the user is entitled to may not be affected. Explicit changes may not be made to entitlements when a user is put on hold. Suspension: Explicit changes may not be made to the user's entitlements and their counters when a user is suspended. If a user is re-instated then any existing entitlements the user is qualified for may still be valid. Pro-rated Credit: For paid entitlements, each specific implementation or use case may define what the pro-ration criteria will be.

### Reporting

One or more of the following reports may be generated for each entitlement: number of new listings listed with an entitlement during a period, number of new listings by benefit during a period, GMV (gross monetary value) of listings listed with an entitlement during a period, or number of sellers adopting this entitlement during a period.

### Recovery and Reconciliation

In an example, entitlements provisioning (application) may go wrong due to many factors. Such factors may include mis-configuration of the benefit rules (e.g., wrong categories specified, wrong start date, or incorrect number of listing benefits configured), system issues (e.g., entitlements code not rolled out on all the boxes within a distributed networked system include multiple servers processing incoming transactions), monthly category rollouts to the site may change or move the eligible categories, or bugs popping up in production that interfere with entitlements.

In certain examples, the factors discussed above may cause the counters to be wrongly counting listings that may not qualify for the benefit or may not count listings that may be eligible for the benefit. In both cases the pricing on the item (transaction) may be wrong (either low or high). This problem may become compounded and magnified if not detected early and as time progresses.

In an example, counters may be used to keep track of the listings that receive the benefit. If a counter value is incorrect, then the fees being charged may be incorrect as well (at least some of them). One problem here may be that an invalid counter may continue to create incorrect fees or incorrect provisioning of the benefit. In certain examples, a recovery plan may allow for the recovery of fees and the counter if something goes wrong. Furthermore, the recovery plan may ensure that the items are truly eligible qualify for the benefits and priced correctly. In an example, the recovery plan may include one or more of the following operations: identifying the problem, running a preliminary report to assess the impact of the problem, deploying the new rules with correct entitlement qualifying criteria, starting a new version of the counter, using the new version of the counter for new listings coming on the site and also as part of the recovery process, or applying an appropriate recovery strategy.

The reporting capability of the recovery and reconciliation (RnR) process may allow the generation of a report prior to the actual recovery process. In an example, reporting may provide insight into the extent of the problem based on data for one day and then extrapolate for the number of days the problem has been on site. Reporting may be run in read-only mode without making any changes to the items (transactions) or entitlements. In an example, the report may show an approximate number of listings affected or the dollar amount of the overall impact. Reporting may help determine what the total revenue impact is or what recovery action should be taken.

In an example, a report may provide one or more of the following details: number of impacted sellers, number of impacted listings, a list of benefit counters affected, a start date of the problem, or an approximate gross merchandise value (GMV) (dollar amount) of the impacted listings. In an example, based on the revenue impact or number of listings impacted, the entity providing for the RnR may pick one or more of the following recovery strategies. Strategy 1: Re-pricing correctly (no ordering guaranteed). In this plan, the recovery process may count all items and re-price them. Re-pricing may include one or more of the following operations: deploying an entitlement fix, creating a new version of the counter (e.g., C2=0), starting evaluating and applying new entitlement criteria or a new counter to affected items, or re-pricing substantially all of the items (even beyond the maximum or cap value) until they are correctly priced.

One or more of these recovery operations may have operational impact because the recovery has to catch-up past and future listings coming in even beyond the cap value. Strategy 1 may have no impact to revenue, though, because it may price all items correctly as part of the recovery process. For example, assume an entitlement offers a benefit of five listings at Zero IF and thereafter at 5 cents (rack rate) and is valid for 1 month. Assume further that the following items have the following respective insertion fees: I1 (0), I2 (0), I3 (5), I4 (0), I5 (0), I6 (5), and I7 (0). Assume further that Counter C1=5. With strategy 1, the new counter C2=0 and all the items may be re-priced so that 11 thru 15 may get 0 IF (assuming no new listings are coming in during recovery) and 16 and 17 may be priced 5 cents.

Strategy 2: Benefit the seller. In an example, Strategy 2 works when we narrow down the scope of entitlements (that is, the fix is a subset of the scope of the previous entitlement). For example, originally if the entitlement is configured incorrectly for both Tech & Media categories instead of just the Media category. After the fix it should only apply to Media category). Perform one or more of the following operations: deploy the entitlement fix, create new version of the counter (C2=0), don't fix past items (e.g., don't re-count or re-price), previous benefits given to unqualified items will not be corrected, only count forward with the new counter (in the worst case, the seller may get up to twice the cap or maximum value of the benefit), RYI on old items should evaluate the item against the old entitlement rules and not the new entitlement rules.

For example, assume an entitlement offers a benefit of five listings at Zero IF in Media category and thereafter at 5 cents (rack rate) and is valid for 1 month. Assume further that the entitlement is incorrectly configured for both Tech & Media categories instead of just the Media category. Assume further that the following items have the following respective insertion fees: I1 (0), I2 (0), I3 (0), I4 (0), I5 (0), I6 (5), and I7 (5). Assumer further that Counter C1=5.

With this example of Strategy 2, assuming I1 and I2 were listed in Tech categories & all others in Media category, I1 and I2 incorrectly received the benefit. After the recovery process, the new counter C2=0 (which tracks application of the entitlement after recovery). The seller can still get up to 5 more listings with zero IF if listed in the Media category.

Strategy 3: Similar to above strategy but the new counter starts at current count value instead of resetting to 0. In an example, Strategy 3 will perform one or more of the following operations: deploy the entitlement fix, create new version of the counter (C2=current C1 value), don't fix past items (e.g., don't re-count or re-price) (previous benefits given to unqualified items will not be corrected), only count forward with the new counter (in the worst case seller may get up to the cap value of the benefit), in an example, RYI on old items should evaluate the item against the old rule and not the new rule.

For example, assume an entitlement offers 5 listings at Zero IF in Media category and thereafter at 5 cents (rack rate) and is valid for 1 month. Assumer further that the entitlement is incorrectly configured for both Tech & Media categories instead of just the Media category. Assume further that the following items have the following respective insertion fees: I1 (0), I2, (0), I3 (0), I4 (0). Assume further that Counter C1=4. With Strategy 3, assuming I1 and I2 were listed in Tech categories & all others in Media category, I1 and I2 incorrectly received the benefit. After the recovery process, the new counter C2=4. The seller will get up to 1 more listing with zero IF if listed in the Media category.

Strategy 4: This strategy is a variation of strategy 1. In an example, Strategy 4 will perform one or more of the following operations: deploy the entitlement fix, create new version of the counter (C2=0), start evaluating and applying new counter to all the items, or don't reprice the items that were wrongly given the benefit (e.g., Tech category items) (reprice only those items that didn't get the benefit (e.g., I3 and I6)). This approach may have less operational impact than other approaches because the recovery has to be done only up to the max or cap value (e.g., up to the entitlement limit). In an example, Strategy 4 may have some impact to revenue.

For example, assume an entitlement offers five listings at Zero IF and thereafter at 5 cents (rack rate) and is valid for 1 month. Assume further that the following items have the following respective insertion fees: I1 (0), I2 (0), I3 (5), I4 (0), I5 (0), I6 (5), I7 (0). Assumer further that counter C1=5. With strategy 4, assuming I1 and I2 were given the benefit wrongly even though they didn't qualify they may not be repriced. The new counter C2=0. I3 and I6 may be repriced since they meet the criteria of the fixed entitlement.

Benchmarks: In an example, the RnR system may be configured to process, recover, or reconcile one day's worth of new listings in one day. In certain examples, the RnR system can be configured (by an entity deploying the RnR system) to limit the number of days worth of data that can be recovered depending on the total impact (e.g., revenue, number of transactions, etc. . . . ). In an example distributed networked system, 1 day's worth of new listing may be 10 million, whereas 7 day's worth of new listing may be 70 million. Accordingly, the entity deploying the RnR system may limit recovery according to available system resource.

In the following examples of recovery and reconciliation, the following notification may be used. Rn: Rule that is applied for entitlement benefit (e.g., R1). C(t,v): A counter—with type “t” and version “v” (e.g., C(1,1)). RnC(t,v): Rule “n” which has a counter C(t,v)—a rule that is applied for a entitlement benefit, which increments counter C(t,v). e.g., R1C(1,1). The rule translates to entitlement benefit. E(B): an Entitlement having benefits. E−(b1, b2 . . . ). E1: An entitlement with one benefit—E1(b1) is also referred as E1.

In an example, recovery may happen in the backend; therefore, the seller may only get visibility in VAS/invoice. Prices shown at listing time may differ from the time it is in Invoice.

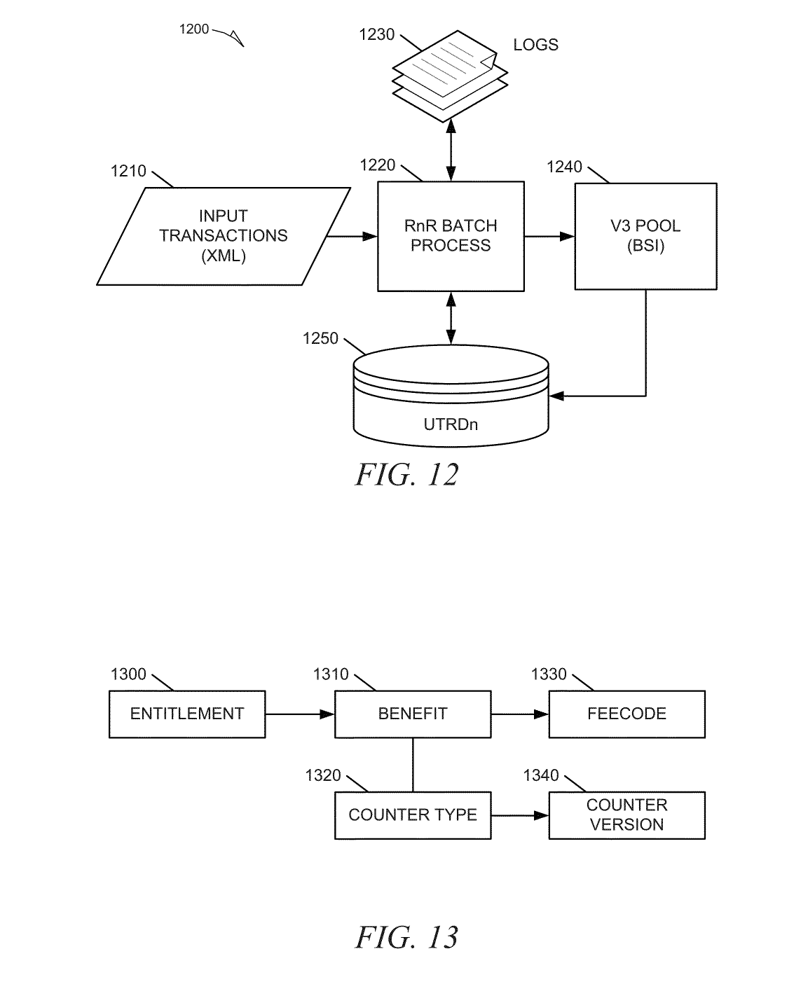

FIG. 12 is a block diagram illustrating an example recovery infrastructure, according to an example embodiment. In an example, a recovery infrastructure 1200 can include input transactions 1210, a RnR Batch Processor 1220, log files 1230, V3 Pool (BSI) 1240, and database 1250.

In an example, an entitlement may have one or many benefits. In certain examples, every benefit is associated with a benefit counter. One benefit can be applied for one or many different fee types (transactions or portion of a transaction). One benefit may be associated with one or many fee codes. A fee code may be used as a key to find the price. In an example, every benefit may have one counter type. A counter type may identify the type of counter associated with a benefit. A counter type may have a counter version. There may typically be only one version created for each counter type. However, in an example, multiple versions may be needed in a case of recovery when something goes wrong. In some examples, an entitlement may also have an entitlement cycle that specifies how frequently entitlement benefits are reset. For example, if an entitlement cycle is monthly, a consumer-to-consumer (C2C) pricing application may reset the benefit counter at a start of each month. An entitlement may also have a charging order. The charging order may be based on a listing session identifier (ID). Charges may be computed during each session. Charges may not based on an item ID. FIG. 13 is a relationship diagram of example relationships between an entitlement, a benefit, a fee code, a counter type, and a counter version.

FIG. 13 is a block diagram illustrating entity relationships for an example entitlement, according to an example embodiment. In an example, an entitlement 1300 can include a benefit 1310, which can include a counter type 1320. A benefit 1310 can also include a feecode 1330. While a counter type 1320 can also include a counter version 1340.

Implementation assumptions: A solution for recovery and reconciliation may include certain assumptions. In an example, the assumptions may correspond to assumptions of an entitlement framework. For example, the entitlement framework may assume that because entitlements don't guarantee order, there may be gaps. Benefits may not be given out in charging order. The same may apply for recovery. In an example, the recovery solution may also assume that entitlement counters are not decremented or new counters may be introduced for recovery. In an example, the recovery solution may also assume that, if an entitlement is already applied to a listing, that listing will continue to get the entitlement, even if the listing qualifies for a higher priority or a lower priced entitlement. In an example embodiment, charges may be based on listing sessions; therefore, it may not be guaranteed that the state after recovery will be exactly the same as if no problem occurred. The use cases presented below illustrate some of these implementation assumptions. The scope of the recovery solution may include recovering from an incorrect entitlement rule or an entitlement rule not deployed on a particular box (server) within a distributed networked system. In certain examples, the scope of the recovery may not include recovering from pricing issues caused by incorrectly configured ranting engine prices.

Reporting: Entitlement infrastructure logs may include details of charges and a current count of each counter in database tables like the following database tables. A USER_ATTR_INSTANCE table: This table may, in an example, contain all the counter instances for a particular user for a given period. For counters that reset after a period (such as a counter that resets every month), there may be an instance for the counter for the seller for each month (e.g., when seller is listing every month, and the listing is qualified for the counter). A USER_LISTING_ATTR table: This table may, in an example, keep track of the values for different counter types for a particular listing. In an example, an instance of a counter type may be incremented once per listing. The same value may be used by many different sessions to compute fees. Tables like these may give a snapshot of a usage of the counter for a period in question.

Example Recovery scenarios: When recovery and reconciliation is needed, the recovery solution may include giving out a benefit for past and future items simultaneously (e.g., when entitlements use a rule based infrastructure). Recovery may include deployment of a rule or running of a batch recovery. In an example, recovery may not involve running a recovery batch if an incorrect rule deployed is a superset of correct rule which should have been deployed (e.g., a missing category in exclusion criteria or end of sale incorrectly out in the future). In certain examples, an entity (e.g., automated system implementing business rules) providing the solution decides to let the seller keep what was given, then the recovery job may not be run. In this case, the correction may be done by re-deploying the corrected rule(s). In an example, recovery may involve running a recovery batch (e.g., an incorrect rule is not a superset (e.g., missing category in inclusion criteria or boxes not having the right rule)). The following example scenarios describe a number of recovery strategies in detail.

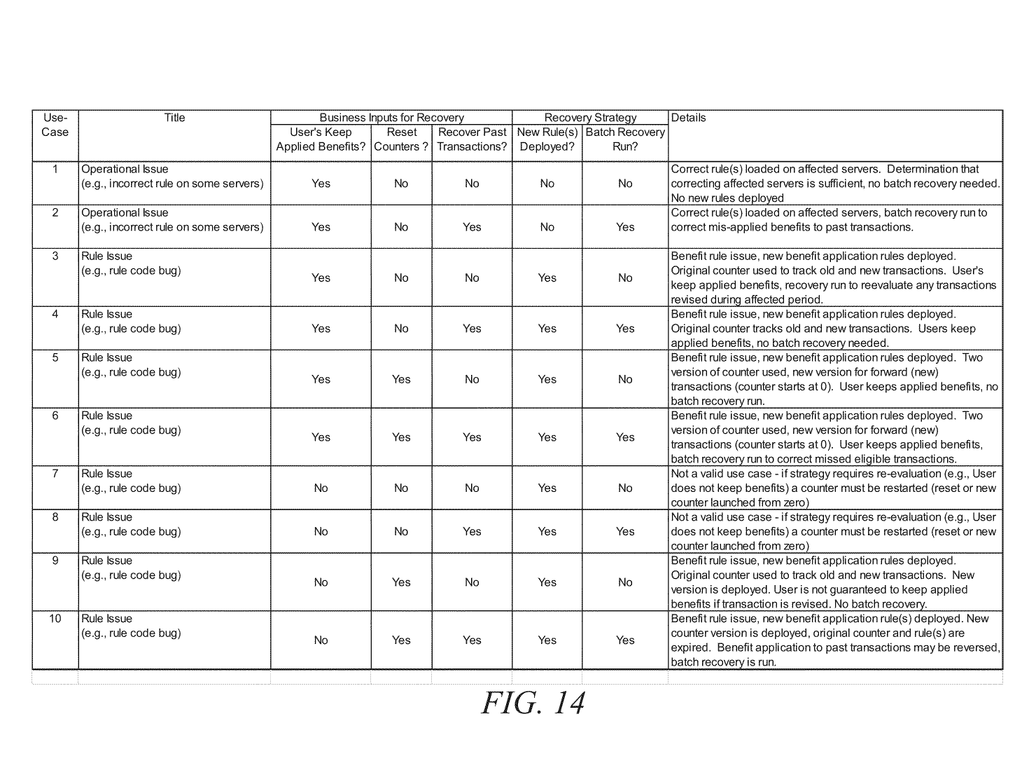

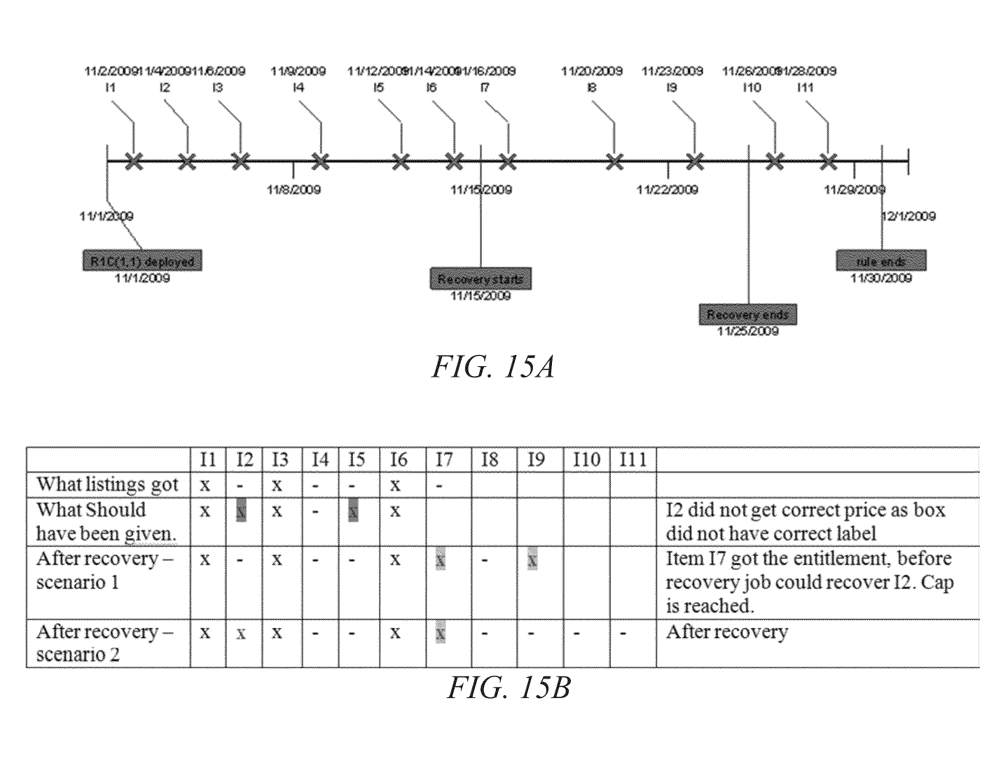

In an example, determining a recovery solution or strategy may include determining whether parties keep what was given, a counter is restarted, or past charges are recovered. For example, if a seller is to keep what was given, the recovery solution may ensure that benefits for the seller are not reversed. Otherwise, benefits previously applied may be re-evaluated. If, after re-evaluation, a charge does not qualify, then new fees may be applied and old charges may be credited. If the counter is to be restarted, a new version of the counter may be started. If an old counter is C(1,1), the new counter may be C(1,2). The new counter may be equal to zero. If the counter is not to be restarted, the same counter type and version (e.g., C(1,1) may be applied to the new rule. If past charges are to be recovered, the charged that have already been given entitlement may be re-evaluated. Otherwise, there may be no need to re-evaluate the past items. FIG. 14 is a table depicting various entitlement recovery solutions, according to an example embodiment. The table in FIG. 14 lists possible recovery solutions based on the above determinations. Operational issue—no code/rule error: This use case occurs if there was a wrong rule deployed in a set of boxes (servers) serving traffic. In this case, listings that are served by these boxes may get incorrect pricing. The rules may be correct in the remaining boxes. In this case, because there are some listings that may have gotten incorrect pricing, recovery may need to be run. Rule label may be poked or a system restarted to get the correct rule. The recovery may give an entitlement price if a listing qualified and did not reach the cap. Consider the following use case. On November 1, rule R1C(1,1) is deployed. On November 15, a problem is discovered that necessitated the running of a recovery job. No new rule needs to be deployed. On November 25, the recovery ends and the price is recovered. On November 30, the rule ends. FIG. 15A is a timeline illustrating an example entitlement recovery scenario, according to an example embodiment. FIG. 15A depicts an example scenario in which a rule is correct and a recovery is run. For example, FIG. 15A may depict a scenario where an incorrect rule was deployed to a set of servers. The servers with an incorrect rule may subsequently process transactions with incorrect pricing (e.g., apply incorrect entitlements). In this example, recovery may be run to correct the incorrectly priced transactions after the correct rules are deployed to the affected servers.

FIG. 15B is a table depicting various recovery scenarios based on an example timeline, according to an example embodiment. FIG. 15B depicts an example recovery scenarios—no new rule.

As shown in FIG. 15B, Item I2 did not get entitlement, even though it was qualified to get the special price. In this example, after the problem (transaction processing error) was discovered, recovery was run. This may have resulted in either of the following two scenarios. Scenario1—forward listing takes the entitlement: Since while recovery is running, forward listings are also competing for getting the same counter. In this case, listings I7 and I8 get the counter and cap is reached. As we see—after recovery—the scenario may not be the same as what should have been given. Item I2 and item I5 may not be given entitlement price. Scenario2—recovery uses the entitlement: In this case, recovery corrected the charge on item I2, along with new item I7, which got the entitlement. Also in this case after recovery—the scenario may not be the same as what should have been given. Item I5 may not be given the entitlement price.

In some examples, recovery is based on rule/code issues—new rule needs to be deployed: In this scenario, rule was incorrect. Code change is needed to correct the rule, which needs to be tested and rolled to production; old rule needs to be ended. A new counter version may be deployed—depending on the recovery strategy.

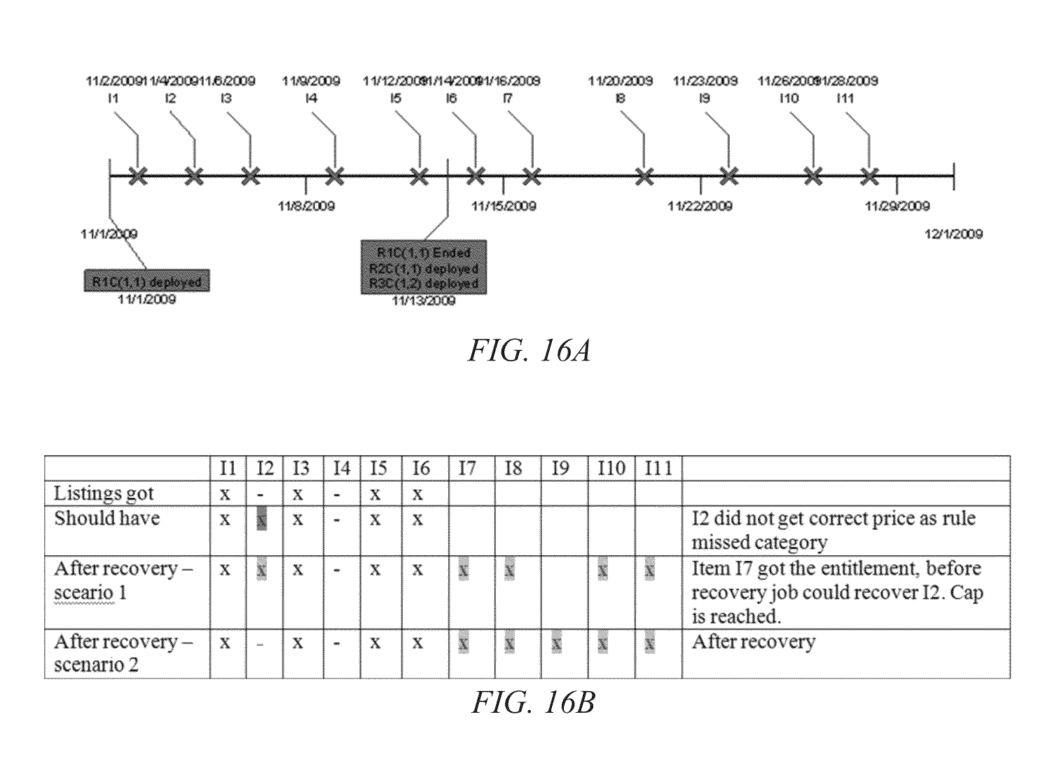

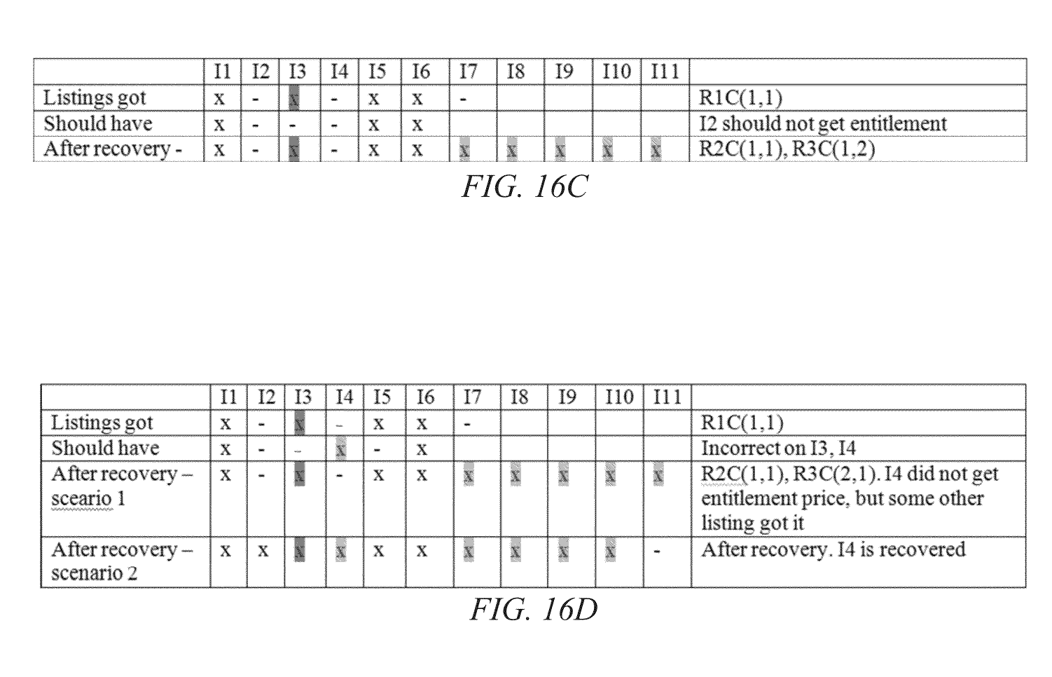

In an example, seller keeps what was given, new counter version: Business rules determine that recovery should leave the listings that got the entitlement, but going forward correct the rule. In this strategy the charges that got the entitlement price will be retained, and a new counter is started with the new rule. In worst case for business (e.g., revenue impact), but best case for seller, seller could get double benefit. FIG. 16A is a timeline illustrating an example entitlement recovery scenario, according to an example embodiment.

In this example, FIG. 16A depicts a scenario in which there is an incorrect rule-seller keeps what was given, same counter. In this case, Rule 1 (R1) with Counter C(1,1) is deployed on November 1. This rule has an error, and needs to be changed. Since recovery strategy is to “Keep what is given”—which is benefit to the seller—new rules will need to deployed to achieve the goal. On November 13, a new rule set is deployed that ends the rule R1C(1,1) (this rule was deployed from November 1-November 30—which is ended (removed from the rule set))), deploys a new rule R2C(1,1) (Rule R2 is the same rule as of R1, but rule end date is updated as Novebmer 13, thus the new rule period is from November 1 to November 13; This will enable listings that got the old rule entitlement, keep it), deploys a new rule R3C(1,2) (this is the new corrected rule—with start date November 1, end date as November 30. A new counter version C(1,2) is applied). In the worst case scenario (from a perspective of the business), the seller gets twice the benefit, from C(1,1) and C(1,2). Recovery may be optionally run, based on business decisions, to reprice items which were listed prior to deployment of the new rule.

FIG. 16B-16D are tables depicting various recovery scenarios based on an example timeline, according to an example embodiment.

Example, use cases (recovery scenarios) include missing category in inclusion criteria, missing category in exclusion criteria, or missing category in exclusion and inclusion criteria. FIG. 16B depicts the missing category in inclusion criteria use case, according to an example. In this case there are certain items that should have gotten the entitlement price, but did not get so since the rule was incorrect. In this case—the listings that got entitlement should have gotten the benefit, but there are some that were charged incorrectly. Missing category in inclusion criteria—I2 should have gotten, but did not get the entitlement. As seen in FIG. 11G, the seller benefits in this strategy. The seller got 4 listings (I1,I3,I5,I6) on R1C(1,1), and another 5 listings on R2C(1,2).

FIG. 16C depicts the missing category in exclusion criteria use case, according to an example. In this case there are certain items that should not have gotten the entitlement price, but got so, since the rule was incorrect. The listings that incorrectly got the entitlement price should keep the entitlement. Missing category in exclusion criteria—I3 should not get, but got the entitlement. As seen from FIG. 11H, seller benefits in this strategy. He got 4 listings (I1,I3,I5,I6) on R1C(1,1), and another 5 listings on R3C(1,2). Seller keeps what was given. Even though listing I1 qualifies under the rule, it cannot be double counted under new rule—R3C(2,1)

FIG. 16D depicts the missing category in exclusion and inclusion criteria use case, according to an example. In this case there are certain items that should not have gotten the entitlement price, but got so, and others that should have the entitlement price but did not get so, since the rule was incorrect. The listings that incorrectly got the entitlement price should keep the entitlement. Listings that should get the entitlement—may be recovered by recovery process. As seen from FIG. 16D, seller benefits in this strategy. He got 4 listings (I1,I3,I5,I6) on R1C(1,1), and another 5 listings on R3C(1,2).

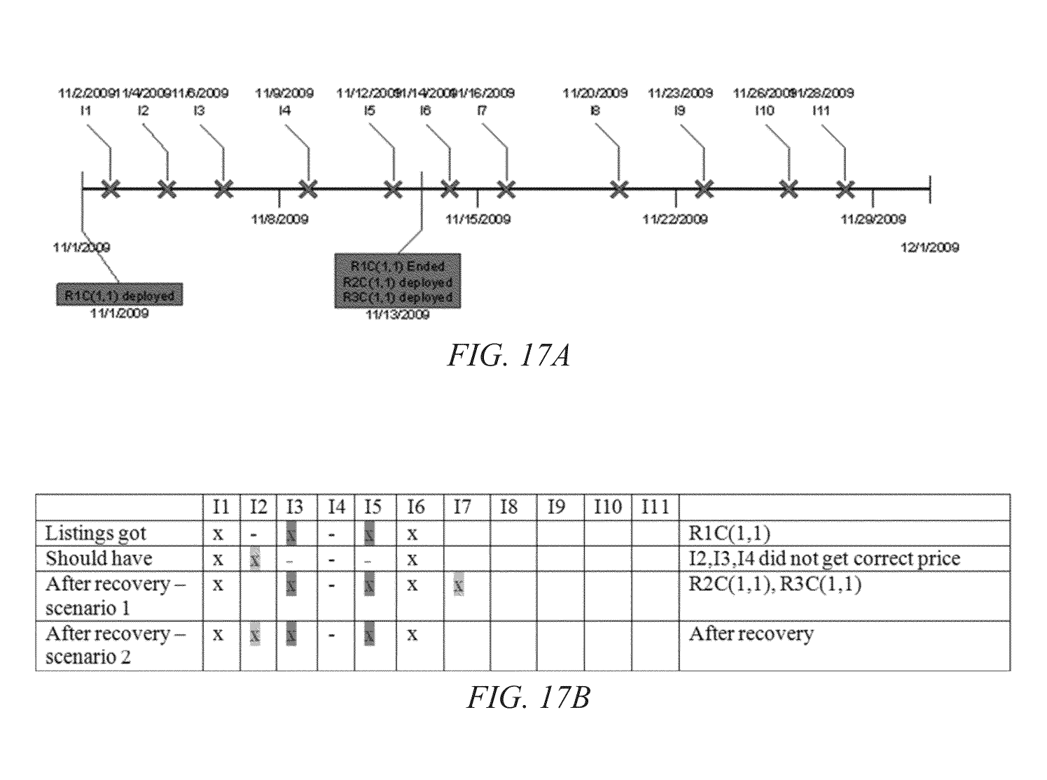

FIG. 17A is a timeline illustrating an example entitlement recovery scenario, according to an example embodiment. In this example, the seller keeps what was given, new rule deployed, same counter: Business decides to leave the listings that got the entitlement, but going forward to correct the rule. Keep the same counter to minimize the impact to business revenue. FIG. 17B is a table depicting various recovery scenarios based on an example timeline, according to an example embodiment.

FIG. 17A depicts an example of incorrect rule-seller keeps what was given, start new counter. This is a modification of the above rule—where the new rule is also counting against the old counter. So seller keeps the entitlements he got, but does not get more benefit than what is promised. On November 13, a new rule set is deployed that ends the rule R1C(1,1) (this rule was deployed from November 1-November 30—which is ended (removed from the rule set)), deploys a new rule R2C(1,1) (Rule R2 is the same rule as of R1, but rule end date is updated as November 13, thus the new rule period is from November 1 to November 13; this will enable listings that got the old rule entitlement, keep it), and deploys a new rule R3C(1,1) (this is the new corrected rule—with start date November 1, end date as November 30; A same counter C(1,1) is applied to the rule). FIG. 17B depicts example incorrect rule scenarios that may require recovery to be run.

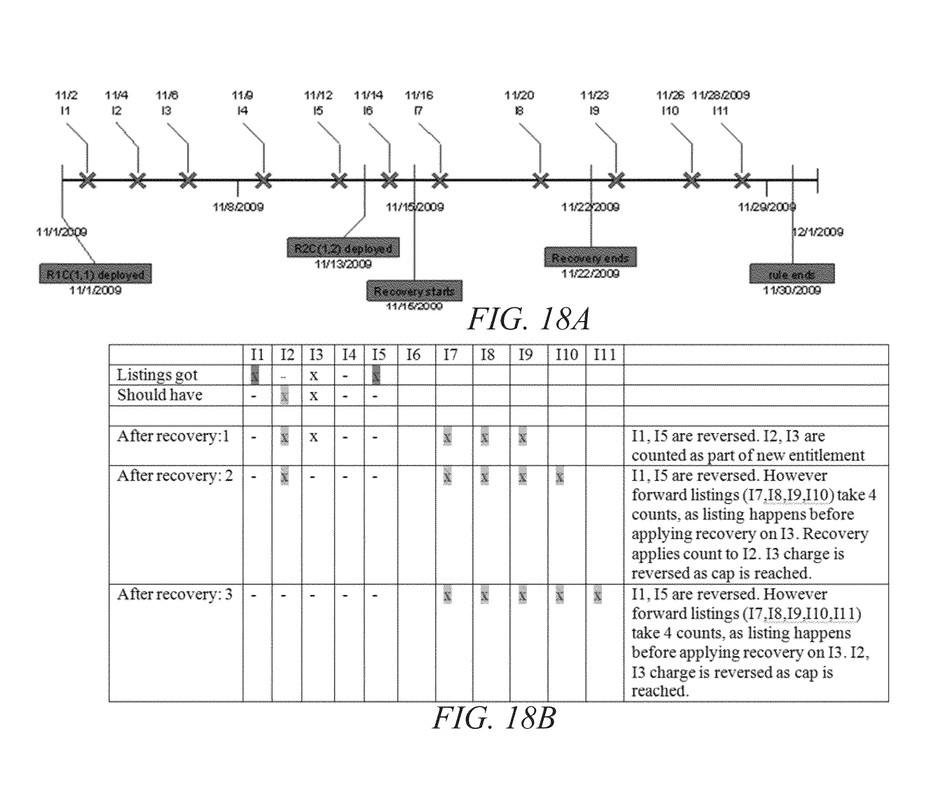

FIG. 18A is a timeline illustrating an example entitlement recovery scenario, according to an example embodiment. FIG. 18B is a table depicting various recovery scenarios based on an example timeline, according to an example embodiment.

In another example use case, old charges are corrected, seller not to exceed maximum benefit. A rule R1C(1,1)—which designates a rule R1 deployed with counter C(1,1), is deployed on Nov. 1, 2009. The rule starts from November 1 and ends on November 30. The rule specifies 5 free Insertion fees (Cap). This rule has an error, and needs to be changed. Since the rule is incorrect, and seller should not get what was given erroneously, the old rule is decommissioned, and a new rule is applied. On November 13, new rule set is deployed that ends the rule R1C(1,1) (this rule was deployed from November 1-November 30—which is ended (removed from the rule set)), and deploys a new rule R2C(1,2) (new rule R2, which has a start date November 1 and end date November 30 (same as R1), is deployed; A new version of counter C(1,2) is applied to the rule, which starts from 0. FIG. 18A depicts an example of incorrect rule, deploy new rule.

At recovery—the listings that got the entitlement are re-evaluated. If a listing was erroneously given entitlement, then the charge is reverted. Recovery may need to be run in this case. FIG. 18B depicts example recovery scenarios (“x” denotes items that got the entitlement price).

In an example, the recovery may be a multi-step process. Referring back to FIG. 12. There may two primary components, which are responsible to pull the items and run recovery on them. Component 1 (RnR batch 1220)—This batch may handle the following operations: Pulling the items, loading the items, sending a request to a pool (e.g., V3 POOL 1240) where the RnR command may reconcile and recover the fees, generating reports. Component 2 (RnR Command)—This command may take care of the actual recovery. It may take the base fees from a LISTING_SESSION_DETAIL_PTx table and execute an RTP or entitlement rules engine with the sessions retrieved from a LISTING_SESSION_ATTR_PTx table. The new fee may be compared with the previous charge and may be adjusted if there is any change in the fee. It may also consider the strategy to exclude the undercharge use case.

Batch High Level Design. The RnR batch 1220 may identify all the items that need to be recovered based on the input provided to the batch. This can be a XML file (e.g., input transactions 1210) with some mandatory tags and lot of optional tags. The recovery strategy may also be passed as an input (not shown). Different queries may be created or used based on the available index. Several filters may be created for the attributes which are not part of the query. First, the batch (e.g., RnR Batch 1220) may choose the best query available for the given input and may fetch the items from LISTING_SESSION_ATTR_PTx table. Then, the batch may apply the filters to get the final set of items which could have been potentially impacted due to rules issue. All the selected items may be pushed to a file and may be loaded to the RnR input table EBAY_ITEMS_RTPROMO using, for example, a SQL loader tool. The batch may run on a different mode to process the selected items. The actual recovery may be done by the RnR command deployed on a pool (e.g., V3 Pool 1240). The batch may construct the URL with the Item ID and seller ID and will send it to the pool.

RnR Command High Level Design. The command (or batch) may send the request to the pool with item id and seller id. It may also take more than one item, which may be configurable. For every item, the batch may validate the item and fetch all the sessions from the LSA/LSD tables. The batch may take the base fees from LSD and reevaluate the promotions and entitlements. The base fees may be passed with the session history to RTP or Entitlement rule engines. A high watermark check may not be performed. If the Fee qualifies only for RTP, then the RTP fee may be applied on the base. The new fee may be compared with the previous charge. If the new fee is less than the previous charge, the old fee may be credited and the new fee may be charged. If the Fee qualifies for Entitlement alone, the entitlement may be applied and the counter may be incremented. If the new fee is less than the previous charge, then the entitlement may be applied and the fee may be adjusted. In case the new fee is higher than the previous charge due to entitlement, then the fee may be adjusted only if the strategy is to adjust the undercharge as well. Otherwise, the fee may not be adjusted. However, if the user does RYI on the item, then the fee may be adjusted if the counter is still available. As more than one item from a seller can be processed at the same time, the recovery may be treated like the Bulk flow. The batch may get all the entitlements and filter out the entitlements which might increase the fee if the strategy is to exclude the undercharge use case. The batch may pre-increment the counter and apply that rule and adjust the fee accordingly. If the Fee qualifies for both RTP and Entitlement, that batch may try to apply the entitlement first as explained in the above step. If the entitlement runs out, the batch may use the RTP and adjust the fee if there is a difference.

Table 1, shown below, includes an example XML schema to control input for recovery, according to an example embodiment.

TABLE 1
Example XML Schema

```
<?xml version=“1.0”?>
<xs:schema xmlns:xs=“http://www.w3.org/2001/XMLSchema”
elementFormDefault=“qualified” attributeFormDefault=“unqualified”>
  <xs:simpleType name=“booleanType”>
  <xs:restriction base=“xs:string”>
    <xs:enumeration value=“true”/>
    <xs:enumeration value=“false”/>
  </xs:restriction>
  </xs:simpleType>
  <xs:complexType name=“RTPromoBatchInputType”>
  <xs:complexContent>
    <xs:restriction base=“xs:anyType”>
    <xs:all>
      <xs:element name=“StartTime” type=“xs:dateTime”/>
      <xs:element name=“EndTime” type=“xs:dateTime”/>
      <xs:element name=“RuleSetId” type=“xs:string” minOccurs=“0”/>
      <xs:element name=“EntitlementLabelId” type=“xs:string”
minOccurs=“0”/>
      <xs:element name=“ExcludeUnderCharge” type=“booleanType”
minOccurs=“0”/>
      <xs:element name=“ExcludeRTP”
      type=“booleanType” minOccurs=“0”/>
      <xs:element name=“IsStoreSeller”
      type=“booleanType” minOccurs=“0”/>
      <xs:element name=“IsPowerSeller”
      type=“booleanType” minOccurs=“0”/>
      <xs:element name=“IsBusinessSeller”
      type=“booleanType”
minOccurs=“0”/>
      <xs:element name=“SellerResidenceCountries” minOccurs=“0”>
      <xs:complexType>
        <xs:complexContent>
        <xs:restriction base=“xs:anyType”>
          <xs:sequence>
          <xs:element name=“Id” type=“xs:integer” minOccurs=“0”
maxOccurs=“unbounded”/>
          </xs:sequence>
        </xs:restriction>
        </xs:complexContent>
      </xs:complexType>
      </xs:element>
      <xs:element name=“Sites” minOccurs=“0”>
      <xs:complexType>
        <xs:complexContent>
        <xs:restriction base=“xs:anyType”>
          <xs:sequence>
          <xs:element name=“Id” type=“xs:integer” minOccurs=“0”
maxOccurs=“unbounded”/>
          </xs:sequence>
        </xs:restriction>
        </xs:complexContent>
      </xs:complexType>
      </xs:element>
      <xs:element name=“SaleFormats” minOccurs=“0”>
      <xs:comptexType>
        <xs:complexContent>
        <xs:restriction base=“xs:anyType”>
          <xs:sequence>
          <xs:element name=“Id” type=“xs:integer” minOccurs=“0”
maxOccurs=“unbounded”/>
          </xs:sequence>
        </xs:restriction>
        </xs:complexContent>
      </xs:complexType>
      </xs:element>
      <xs:element name=“Categories” minOccurs=“0”>
      <xs:complexType>
        <xs:complexContent>
        <xs:restriction base=“xs:anyType”>
          <xs:sequence>
          <xs:element name=“Id” type=“xs:integer” minOccurs=“0”
maxOccurs=“unbounded”/>
          </xs:sequence>
        </xs:restriction>
        </xs:complexContent>
      </xs:complexType>
      </xs:element>
      <xs:element name=“FeeCodes” minOccurs=“0”>
      <xs:complexType>
        <xs:complexContent>
        <xs:restriction base=“xs:anyType”>
          <xs:sequence>
          <xs:element name=“Id” type=“xs:integer” minOccurs=“0”
maxOccurs=“unbounded”/>
          </xs:sequence>
        </xs:restriction>
        </xs:complexContent>
      </xs:complexType>
      </xs:element>
      <xs:element name=“HostURL” type=“xs:string” minOccurs=“0”/>
      <xs:element name=“Timeout” type=“xs:int” minOccurs=“0”/>
      <xs:element name=“SleepTime” type=“xs:int” minOccurs=“0”/>
      <xs:element name=“FileSize” type=“xs:double” minOccurs=“0”/>
      <xs:element name=“ThreadSize” type=“xs:int” minOccurs=“0”/>
      <xs:element name=“FetchSize” type=“xs:int” minOccurs=“0”/>
      <xs:element name=“OutputDir” type=“xs:string” minOccurs=“0”/>
      <xs:element name=“ConsecutiveError”
      type=“xs:int” minOccurs=“0”/>
    </xs:all>
    </xs:restriction>
  </xs:complexContent>
  </xs:complexType>
  <xs:element name=“RTPromoBatchInput”
  type=“RTPromoBatchInputType”>
  <xs:annotation>
    <xs:documentation>root element for RTPromoBatch job
input</xs:documentation>
  </xs:annotation>
  </xs:element>
</xs:schema>
```

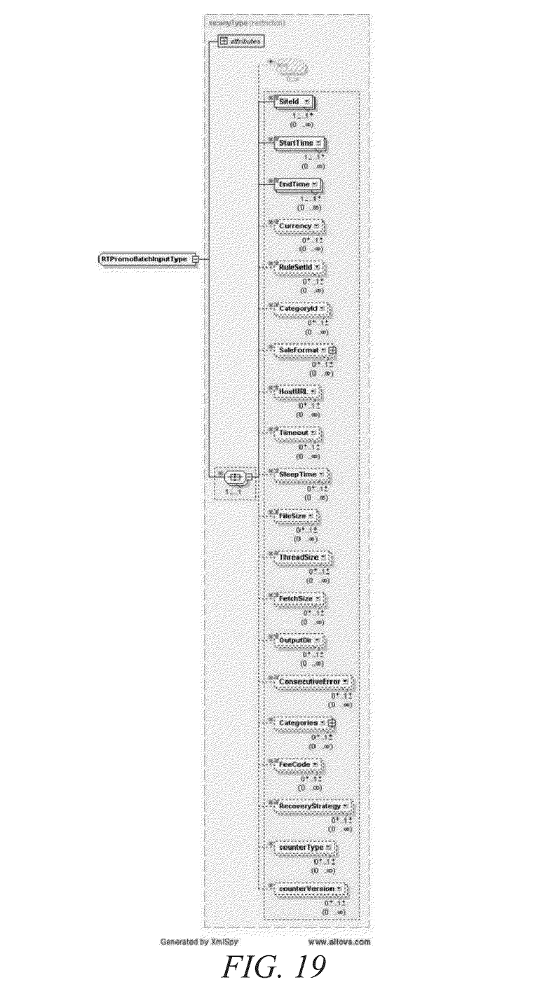

FIG. 19 is a block diagram illustrating an example data structure for an input file for recovery, according to an example embodiment. The recovery batch may include input data pull to determine a recovery strategy or to recover a specific counter and version. The recovery batch may also include XSD for input XML file, as depicted in FIG. 19.

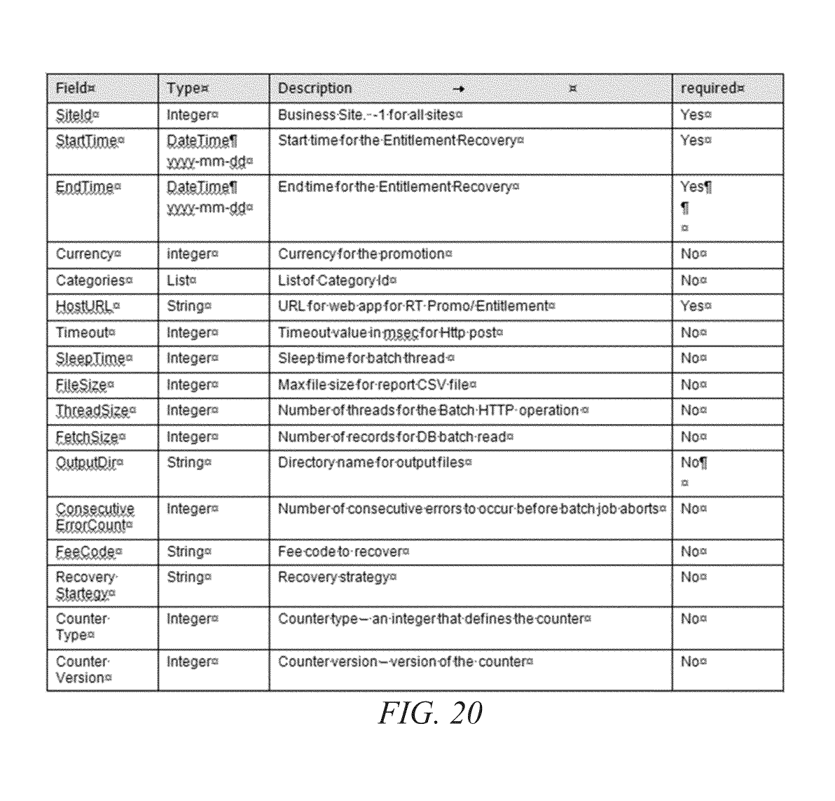

FIG. 20 is a table depicting various example attributes included within an example data structure for batch recovery, according to an example embodiment.

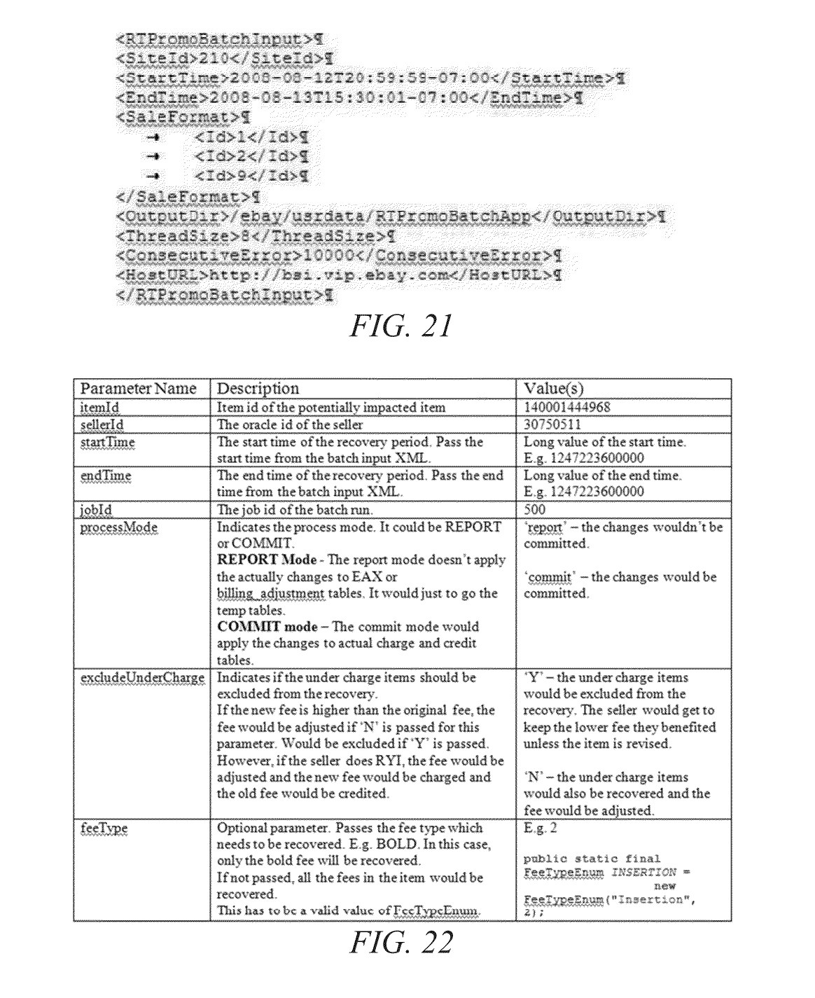

FIG. 21 is a code fragment illustrating an example data structure for a recovery input file, according to an example embodiment. In this example, the code fragment in FIG. 20 is an XML input file.

In an example, the actual recovery may be done by the recovery command. The recovery command may be responsible to validate the request, re-evaluate the RTP and Entitlement rules, or compare the new fee with the old fee and adjust the fee if there is a difference. In an example, the RTP recovery may be a two step process. First, all the selected items may be reconciled. The new charges and credits may be recorded into temp tables. After that the reconciliation report may be generated. In certain examples, the business may review the report and then the recovery may be run, which may move temporary charges to actual charge and credit tables. In some examples, automated business rules may be utilized to conduct the review. This flow may still be supported for the use case where there is no entitlement on the same feature for which the RTP recovery needs to be run. In an example, there may be an assumption that this flow may never be executed if the feature also has an entitlement. However, the following changes may be made to improve the performance of the reconciliation flow as well as to filter the items if the fee being recovered also qualifies for entitlement. The HWM calculation logic may be removed and all the session may be reconciled only once. The old fees may be retrieved from listing session detail (LSD). In an example, during the recovery, the charges and credits may be posted as long as there is no fee impact since the reconciliation is executed.

In an example, the entitlement recovery may be a single-step process. As the entitlement may depend on the count value, it is possible that it may not be recovered in multiple steps like the RTP recovery. The counter may be incremented in real time, enabling a single transaction; otherwise the listings (transactions) may qualify beyond the cap as the counter is not incremented. Once the corrected rule is deployed, the live listings may also take up the next available count if the rule is still active. For qualified items, the counter may be pre-incremented and the fees may also be recovered in the same step.

In an example, entitlement recovery may be run in debug mode. The main purpose of this flow is to provide a debug mode in which the recovery may reconcile the fees, but may not apply the changes. In this example, the counter may not be incremented. As a result of this, more listings may qualify, which may give incorrect estimation if the cap is small. The temp charge and credit tables may still be populated.

FIG. 22 is a table depicting various example input parameters to an example recovery process, according to an example embodiment. In an example, the input parameter depicted in FIG. 22 may be required to process the recovery.

In an example, recovery tasks may include, validating a request. Validation may make sure that the inputs are valid and the item is in a recoverable state. If there is any error, the status may be updated with the reason code. Once the item is validated, the recovery process may fetch the sessions, reevaluate the fees, or adjust the fee if there is a difference. The new command may parse the input parameters, create a TO, or call a rules recovery controller to recovery the item fees. In an example, the rules recovery controller may execute any of the following operations to reconcile and recover the fees: Validate the input parameters, reevaluate the fees, or recover the fees.

Input validation. In an example, the inputs may be validated before proceeding with the processing and return appropriated error message. If the request is not a legitimate one, then the error in the response may be returned. The batch may log the error in the log (e.g., log files 1230). If the request is valid and there is an error while processing, the error code may be updated in a table and the status may be set to FAILED. The item id, seller id and job id should be a positive number and may be greater than zero. The startTime and endTime may not be null and may be a valid dates. The batch may make sure the processMode is not null and validate the value. The processMode should be either ‘report’ or ‘commit’. The batch may make sure the excludeUnderCharge is not null and the value is either ‘Y’ or ‘N’. The batch may validate the status of the item, query the table EBAY_ITEMS_RTPROMO, or check the status of the entry. The status may be 1. The possible values of STATUS may be as follows: 0—New, 1—In-process, 2—Successfully processed, 3—Successful with warnings, 4—Failed. The batch may get the saleBo for the given item id. If the item is not found, mark it as Failed with an appropriate reason code. In this example, if all of the above validations succeed, then the batch may continue with the recovery.

Rules reevaluation. In an example, rules reevaluation may include reevaluating the rules for the given item. It may load the sessions and call the RTP and Entitlement rules engines to reevaluate the rules. The batch (e.g., RnR Batch 1220) may create a new interface (e.g., RecoverPricingRulesI), which may provide a method to re-evaluate the rules and return the fees. The new method may take the item id and the listing date as inputs. The batch may fetch all the sessions for the given item id and create the RTPOptimizerContextFactory. If it's a GTC item, the batch may fetch the rows for the given renewal period. The batch may use the last session as the current session. The batch may call RTPOptimizer to calculate the promotions and create the debit list from the rules returned by the RTP Rule Engine. The batch may create an EntitlementOptimizerContextFactory from the RTPOptimizerContextFactory and call the EntitlementService to get the entitlement fees. The batch may filter the rules. If a fee gets the same Rule that was applied earlier and there is no change in the fee, then the batch may keep that rule and filer out the remaining rules. If the fee gets a new rule because of which the fee goes up, then the batch may filter rule based on the recovery strategy (excludeUnderCharge param). If excludeUnderCharge has ‘Y’, then the batch may filter the rule, otherwise the batch may keep the rule. The batch may sort the remaining rules and pre-increment the counters. The batch may apply the incremented rule and mark the FeeAdjustment for the recovery. The batch may create a final debit list and return the fees.

Fees recovery. The recovery task may compare the new fees with the old charges and adjust the fees if there is a difference. The fees that are flagged for recovery may be recovered as the fee comparison may already be done and the counter may have been incremented. The USER_ATTR_INSTANCE table may already populated by the pre-increment flow. So, we may just need to populate the USER_LISTING_ATTR table with the counter information along with the new charge and the credit. If the fee is not flagged for recovery, the batch may compare the new fee with the previous charge. If new fee is higher than the old fee, then the batch may recover the fee only if excludeUnderCharge is set to ‘N’. Otherwise, the batch may recover the fee as the new fee is lower than the old fee.

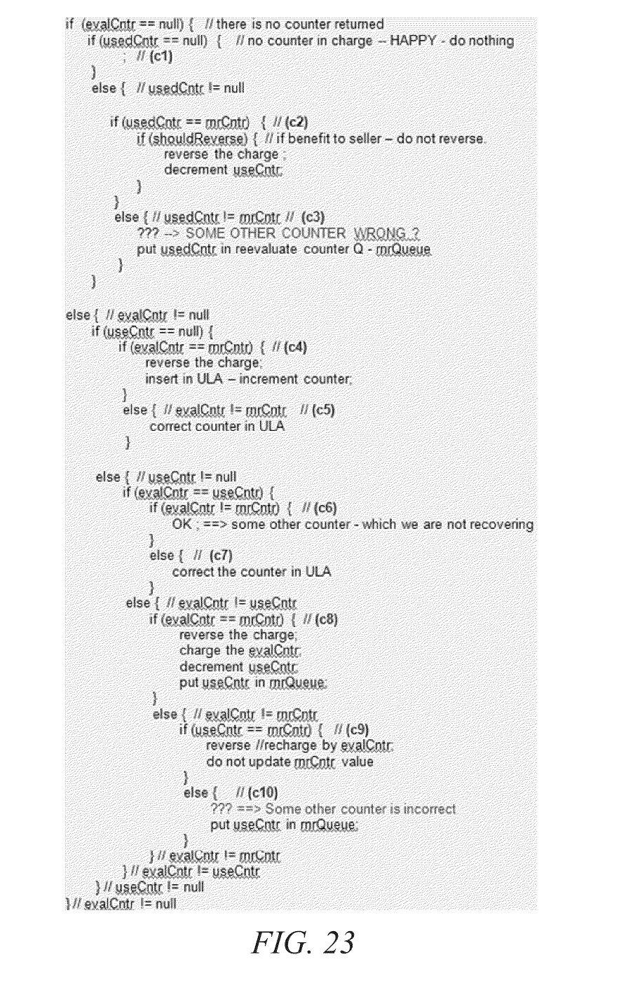

FIG. 23 is a code listing illustrating an example recovery algorithm, according to an example embodiment.

The following are descriptions of variables used in the example recovery algorithm (depicted in FIG. 23): usedCntr—the counter that is to be recovered—say C(1,1), rnrCntr—counter used for recovery only, for affected items—say C(1,2), 1stCntr—counter to count forward listings, new listings while recovery is ongoing—C(1,3), newCntr—new counter—for pricing and charging, this brings the state to what should be. C(1,4). Thus the recovery may necessitate three versions, C(1,2), C(1,3) and C(1,4), to be created. usedCount—old count used by usedCntr—counter that needs to be recovered, usedCntr is disabled—rnrCntr, 1stCntr and newCntr is provisioned—this may be needed as recovery may need to happen on active entitlements. There is a chasing

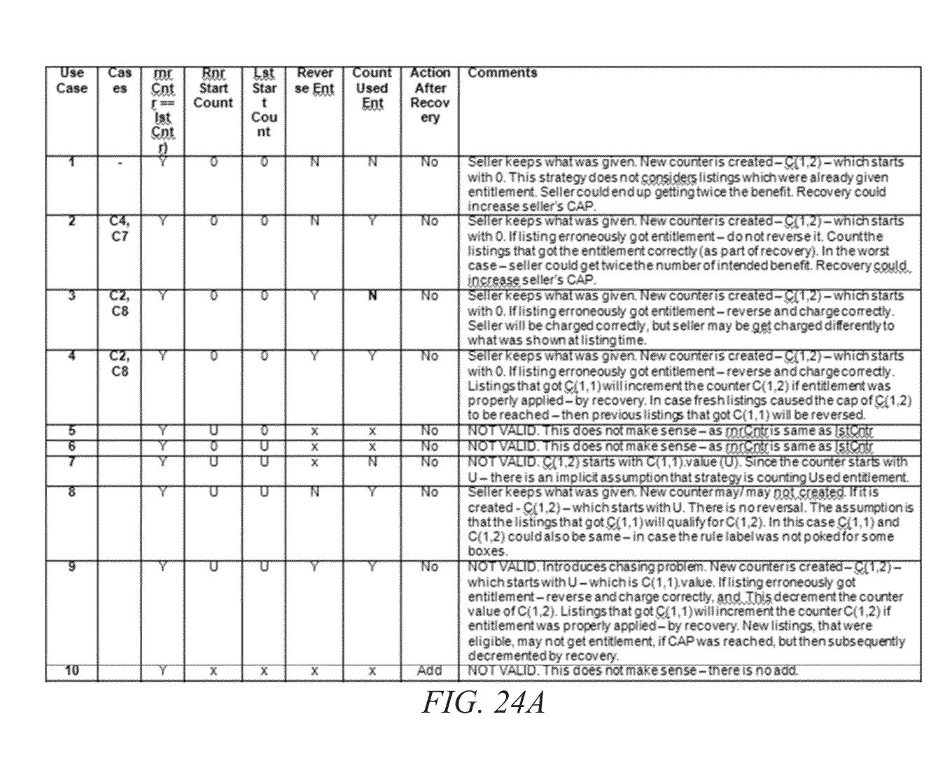

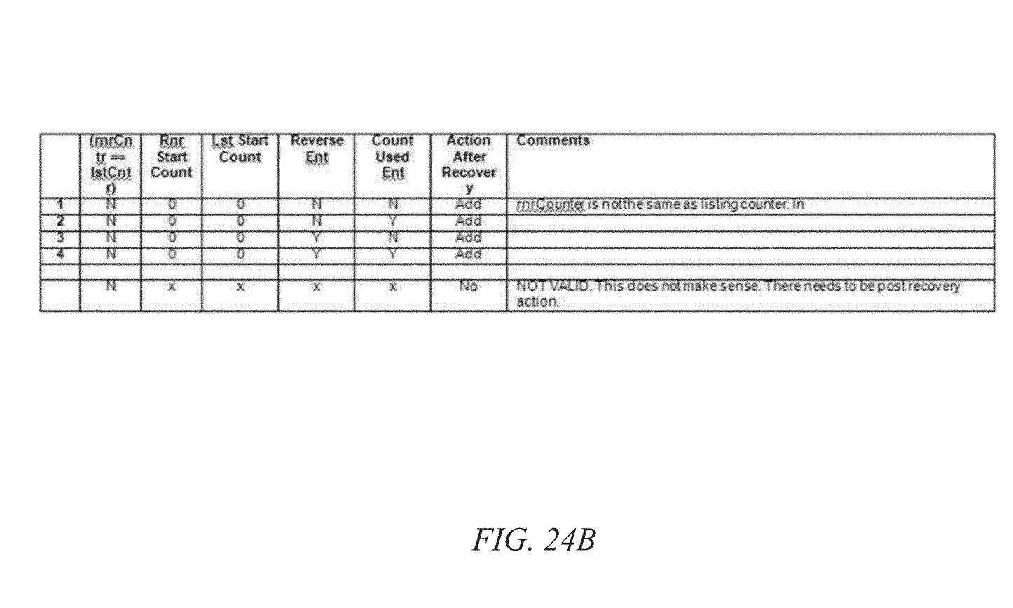

Conditions to consider may include: (a) (rnrCntr==1stCntr) ?Y/N, (b) rnrStartCount=0/usedCount ?0/U, (c) 1stStartCount=0/usedCount ?0/U, (d) reverseEnt->Y/N—should the logic reverse the entitlement, (e) countUsedEnt->Y/N—should the logic consider the listings that already got the entitlement?, (f) actionAfterRecovery—no-action, or newCntr.value=1stCntr.value+rnrCntr.value ?No/Add. If (rnrCntr==1stCntr) i.e. if these 2 are same—then-no-action is needed after recovery, since rnrCntr is the newCntr. This case is a single phase recovery—A new counter deployed. evalCntr: Evaluation counter, the counter that was returned by recovery, usedCntr: The counter that is used on a charge, rnrCntr: The counter that is used for recovery. FIG. 24 is a table depicting various recovery use cases according to an example embodiment. In an example, the use cases depicted in FIG. 24 can be used in deriving a recovery algorithm.

FIG. 24A is a table depicting various recovery use cases according to an example embodiment.

Use Case 1: Solve the issue for future charges, do nothing for charges already given (err on seller side). There is a wrong rule that is deployed, where the exclusion criteria missed a category. Business decides to not reverse the charge, do nothing for the charges already given, but going forward redeploy the correct rule. The issue goes away with future charges. As part of the recovery, new rule may be redeployed. The old rule may be retired. The counter version may be incremented. A new counter may be deployed, with version 2. New charges that qualify for the benefit may get the new benefit. A separate recovery process may not be run. Older listings may keep what-ever pricing was given. At RYI, if a listing qualifies, it may get the new counter version, charge may increment the new counter version. If not—then the fee may be charged.

Use Case 2: Solve the issue for future charges, try recover the count for listings already given to limit the revenue loss, do nothing for charges already given (err on seller side) In this case there is a wrong rule deployed. Business decides to not reverse the charge, but for charges already given, re-evaluate the charges. If the charge qualified, increment the counter—if CAP is not yet reached. If the charge did not qualify, or the CAP was already reached, then do not reverse the charge, err on seller side. As part of the recovery, new rule may be redeployed. The old rule may be retired. The counter version may be incremented. A new counter may be deployed, with version 2. New charges that qualify for the benefit may get the new benefit. Recovery process will be run. Going forward the correct rule may be redeployed. The issue may go away with future charges.

Use Case 3/4: Solve the issue for future charges, try recover the count for listings already given to limit the revenue loss. For charges that received entitlement, re-evaluate and if needed—charge. In this case there is a wrong rule deployed. Business decides to re-evaluate the charges already given. If the charge qualified, increment the counter—if CAP is not yet reached. If the charge did not qualify, or the CAP was already reached, then do not reverse the charge, err on seller side. As part of the recovery, new rule may be redeployed. The old rule may be retired. The counter version may be incremented. A new counter may be deployed, with version 2. New charges that qualify for the benefit may get the new benefit. Recovery process may be run. Going forward the correct rule may be redeployed. The issue may go away with future charges.

Use Case 8: Rule is corrected with same counter type and version.

rnrCntr !=1stCntr. This is the case where 2 phase recovery is needed—These use cases are not being considered for Entitlement recovery. In this case (a) usedCntr—the counter that is to be recovered.—say C(1,1), (b) rnrCntr—counter used for recovery only, for affected items—say C(1,2), (c) 1stCntr—counter to count forward listings, new listings while recovery is ongoing—C(1,3), (d) newCntr—new counter—for pricing and charging, this brings the state to what should be. C(1,4). FIG. 24B is a table depicting an additional example entitlement use case, according to an example embodiment. In an example, the use case depicted in FIG. 24B can depict a use case where only a new Counter is needed.

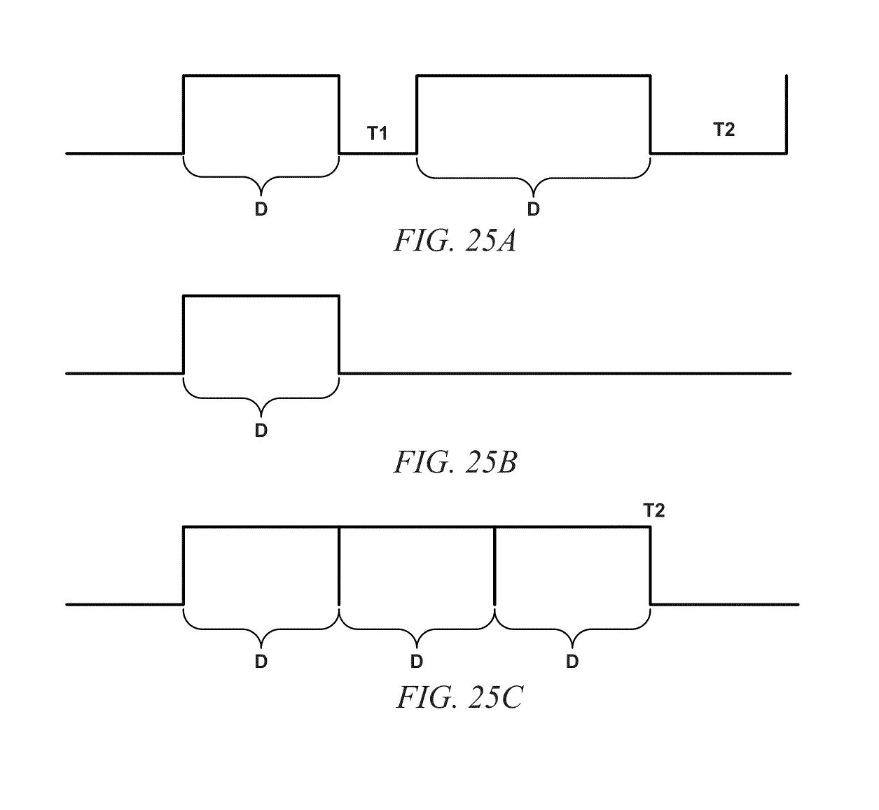

FIG. 25A-25C are diagrams illustrating various entitlement durations, according to an example embodiment. FIG. 25A depicts an example of a long-term entitlement. Duration of entitlement, or ‘BenefitPeriod’ is constant (D)—but there may be gaps between periods—where the entitlement was not active as seller did not meet qualifying criteria in its listings (e.g., T1, T2). FIG. 25B depicts an example of a one-time entitlement defined with a start date and end date. FIG. 25C depicts an example of a recurring entitlement. Recurring entitlements are valid for life of subscription. The entitlement depicted in FIG. 25C may be tied to a subscription.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program embodied in a non-transitory information carrier, e.g., in a machine-readable storage medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

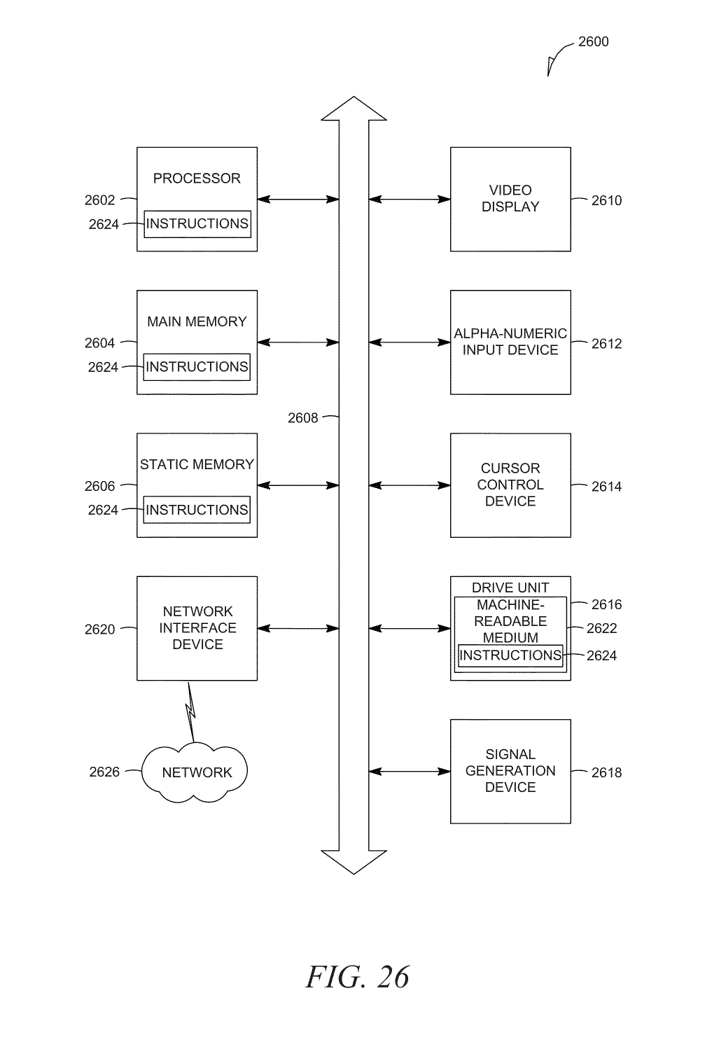

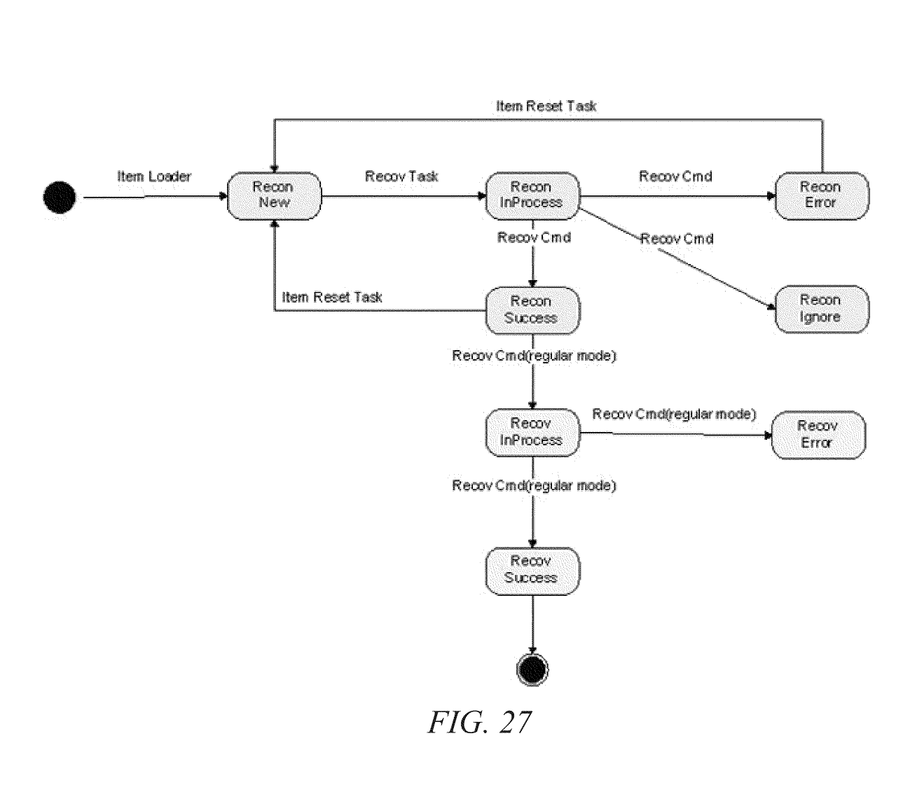

FIG. 26 is a block diagram of machine in the example form of a computer system 2600 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2600 includes a processor 2602 (e.g., a central processing unit (CPU), a graphics processing unit (GPU) or both), a main memory 2604 and a static memory 2606, which communicate with each other via a bus 2608. The computer system 2600 may further include a video display unit 2610 (e.g., a liquid crystal display (LCD) or a cathode ray tube (CRT)). The computer system 2600 also includes an alphanumeric input device 2612 (e.g., a keyboard), a user interface (UI) navigation (or cursor control) device 2614 (e.g., a mouse), a disk drive unit 2616, a signal generation device 2618 (e.g., a speaker) and a network interface device 2620.

### Machine-Readable Medium

The disk drive unit 2616 includes a machine-readable medium 2622 on which is stored one or more sets of instructions and data structures (e.g., software) 2624 embodying or utilized by any one or more of the methodologies or functions described herein. The instructions 2624 may also reside, completely or at least partially, within the main memory 2604 and/or within the processor 2602 during execution thereof by the computer system 2600, the main memory 2604 and the processor 2602 also constituting machine-readable media. The instructions 2624 may also reside, completely or at least partially, within the static memory 2606.

While the machine-readable medium 2622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 2624 may further be transmitted or received over a communications network 2626 using a transmission medium. The instructions 2624 may be transmitted using the network interface device 2620 and any one of a number of well-known transfer protocols (e.g., Hyper Text Transfer Protocol or HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for identifying errors in application of entitlement benefits within a distributed transaction processing system, the system comprising one or more specially configured modules incorporated into the distributed transaction processing system, configured to:
receive, from a client device, data representing an entitlement to be applied to a plurality of transactions within the distributed transaction processing system, the plurality of transactions including one or more parameters;
identify a processing error within the distributed transaction processing system, the processing error associated with an application of the entitlement data to the plurality of transactions, the entitlement data including a benefit element and a benefit element counter that controls a quantity of transactions allowed to receive the entitlement;
assess an impact of the processing error on the plurality of transactions, the assessing including evaluating the one or more parameters of each transaction of the plurality of transactions;
determine, based on the impact, a recovery strategy to minimize the impact of the processing error, the determining the recovery strategy including resetting the benefit counter and processing a subset of the plurality of transactions that received the benefit based on a corrected application of the entitlement; and
implement the recovery strategy on the distributed transaction processing system, the recovery strategy comprising:
deleting the entitlement corresponding to the processing error,
generating a new entitlement benefit application rule corresponding to the identified processing error, the new entitlement benefit application rule corresponding to each of the plurality of transactions that received the benefit due to the identified processing error, and
resetting the benefit counter and applying the benefit according to the new entitlement benefit application rule until the benefit counter reaches a pre-defined limit.

2. The system of claim 1, wherein assessing the impact includes determining a monetary impact associated with the processing error.

3. The system of claim 1, wherein assessing the impact includes generating a report including details regarding the plurality of transactions associated with the processing error.

4. The system of claim 1, wherein implementing the recovery strategy includes deploying a new entitlement benefit application rule that controls the application of the entitlement benefit.

5. The system of claim 1, wherein each transaction of the plurality of transactions correspond to publication of an item listing within a networked marketplace.

6. The system of claim 1, wherein implementing the recovery strategy includes running a batch recovery operation on the plurality of transactions, the recovery batch operation including:
creating a new version of the entitlement counter to track the application of the entitlement benefit during the recovery batch operation; and
re-applying the entitlement benefit to the plurality of transactions associated with the processing error.

7. A method for identifying errors in application of entitlement benefits within a distributed transaction processing system, the method implemented through one or more specially configured modules incorporated into the distributed transaction processing system, the method comprising:
receiving, from a client device, data representing an entitlement to be applied to a plurality of transactions within the distributed transaction processing system, the plurality of transactions including one or more parameters;
identifying a processing error within the distributed transaction processing system, the processing error associated with an application of the entitlement data to the plurality of transactions, the entitlement data including a benefit element and a benefit element counter that controls a quantity of transactions allowed to receive the entitlement;
assessing an impact of the processing error on the plurality of transactions, the assessing including evaluating the one or more parameters of each transaction of the plurality of transactions;
determining, based on the impact, a recovery strategy to minimize the impact of the processing error, the determining the recovery strategy including resetting the benefit counter and processing a subset of the plurality of transactions that received the benefit based on a corrected application of the entitlement; and
implementing the recovery strategy on the distributed transaction processing system, the recovery strategy comprising:
deleting the entitlement corresponding to the processing error,
generating a new entitlement benefit application rule corresponding to the identified processing error, the new entitlement benefit application rule corresponding to each of the plurality of transactions that received the benefit due to the identified processing error, and
resetting the benefit counter and applying the benefit according to the new entitlement benefit application rule until the benefit counter reaches a pre-defined limit.

8. The method of claim 1, wherein assessing the impact includes determining a monetary impact associated with the processing error.

9. The method of claim 1, wherein assessing the impact includes generating a report including details regarding the plurality of transactions associated with the processing error.

10. The method of claim 1, wherein implementing the recovery strategy includes deploying a new entitlement benefit application rule that controls the application of the entitlement benefit.

11. A non-transitory machine-readable storage medium containing instructions, which when executed on a machine, cause the machine to perform operations comprising:
receiving, from a client device, an entitlement to be applied to a plurality of transactions within the distributed transaction processing system, the plurality of transaction including one or more parameters;
identifying a processing error within a distributed transaction processing system, the processing error corresponding to application of an entitlement to a plurality of transactions, the entitlement including a benefit and a benefit counter that controls a quantity of transactions allowed to receive the entitlement;
assessing an impact of the processing error on the plurality of transactions, the assessing including evaluating one or more parameters of each transaction among the plurality of transactions;
determining, based on the impact, a recovery strategy to minimize the impact of the processing error, the determining the recovery strategy including determining whether to reset the benefit counter and whether to process a subset of the plurality of transactions that received the benefit based on a corrected application of the entitlement; and
implementing the recovery strategy on the distributed transaction processing system, the recovery strategy comprising:
deleting the entitlement corresponding to the processing error,
generating a new entitlement benefit application rule corresponding to the identified processing error, the new entitlement benefit application rule corresponding to each of the plurality of transactions that received the benefit due to the identified processing error, and
resetting the benefit counter and applying the benefit according to the new entitlement benefit application rule until the benefit counter reached a pre-defined limit.

12. The non-transitory machine-readable storage medium of claim 11, wherein the instructions that cause the server to assess the impact include instructions that determine a monetary impact associated with the processing error.

13. The non-transitory machine-readable storage medium of claim 11, wherein the instructions that cause the server to assess the impact include instructions that generate a report including details regarding the plurality of transactions associated with the processing error.

14. The non-transitory machine-readable storage medium of claim 11, wherein the instructions that cause the server to implement the recovery strategy include instructions that deploy a new entitlement benefit application rule that controls the application of the entitlement benefit.

15. The non-transitory machine-readable storage medium of claim 11, wherein each transaction of the plurality of transactions corresponds to publication of an item listing within a networked marketplace.

16. The non-transitory machine-readable storage medium of claim 11, wherein the instructions that cause the server to implement the recovery strategy include instructions that run a batch recovery operation on the plurality of transactions, the batch recovery operation including:
creating a new version of the entitlement counter to track the application of the entitlement benefit during the batch recovery operation; and
re-applying the entitlement benefit to the plurality of transactions associated with the processing error.

17. The non-transitory machine-readable storage medium of claim 16, wherein the instructions that cause the server to run the batch recovery operation include instructions to implement a corrected entitlement application rule prior to re-applying the entitlement benefit to the plurality of transactions associated with the processing error.

18. The non-transitory machine-readable storage medium of claim 11, wherein the instructions that cause the server to identify a processing error include instructions to determine that a server within the distributed transaction processing system is operating with an old entitlement benefit application rule.

19. The non-transitory machine-readable storage medium of claim 18, wherein the instructions that cause the server to implement the recovery strategy include instructions to deploy a current entitlement benefit application rule to the server determined to be operating with the old entitlement benefit application rule.

20. The non-transitory machine-readable storage medium of claim 11, wherein the instructions that cause the server to implement the recovery strategy include instructions that run a batch recovery operation on the plurality of transactions, the recovery batch operation including correcting a subset of the plurality of transactions, the subset containing transactions that were eligible for the entitlement benefit but did not receive the entitlement.
